(19) United States
(12) Patent Application Publication
(10) Pub. No.: US 2025/0392374 A1
(43) Pub. Date: Dec. 25, 2025

(54) ENHANCEMENT FOR AIRCRAFT RELAYING CONTINUITY

(71) Applicant: QUALCOMM Incorporated, San Diego, CA (US)

(72) Inventors: Mingxi YIN, Beijing (CN); Kangqi LIU, San Diego, CA (US); Qiaoyu LI, Beijing (CN); Ruiming ZHENG, Beijing (CN); Chao WEI, Beijing (CN); Hao XU, Beijing (CN)

(21) Appl. No.: 18/880,510

(22) PCT Filed: Sep. 7, 2022
(86) PCT No.: PCT/CN2022/117469

§ 371 Date: Dec. 31, 2024

(51) Int. Cl. H04B 7/185; H04W 16/28; H04W 56/00

(52) U.S. Cl. CPC H04B 7/18506; H04W 16/28; H04W 56/0045

(57) ABSTRACT

Methods, systems, and devices for wireless communication are described. A user equipment (UE) may communicate with a network entity via a first relay device of a first aircraft using a first beam associated with the first relay device. The UE may receive via the first relay device of the first aircraft an indication of one or more physical layer parameters associated with a second beam to be used for the communications with the network entity, the second beam associated with the first relay device of the first aircraft or with a second relay device of a second aircraft. The UE may switch from the first beam to the second beam in accordance with the one or more physical layer parameters. The UE may communicate with the network entity using the second beam based at least in part on the switching.

### CROSS REFERENCE

The present Application is a 371 national stage filing of International PCT Application No. PCT/CN2022/117469 by YIN et al. entitled “ENHANCEMENT FOR AIRCRAFT RELAYING CONTINUITY,” filed Sep. 7, 2022, which is assigned to the assignee hereof, and which is expressly incorporated by reference in its entirety herein.

### TECHNOLOGY FIELD

The following relates to wireless communication, including enhancement for aircraft relaying continuity.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support enhancement for aircraft relaying continuity. The described techniques provide for signaling physical layer parameter(s) of the next beam to be used for the relaying aircraft. A user equipment (UE) may communicate with a network entity via a first relay device of a first aircraft (e.g., may be performing relayed communications). The relay device may include any device of the aircraft capable of performing or otherwise supporting wireless communications within a wireless network. The relayed communications may be performed using a first beam associated with the first relay device. Broadly, references to a beam may refer to any beam (e.g., transmit beam or receive beam) or beam pair (e.g., transmit beam/receive beam pair) used for downlink transmissions from the relay device to the UE or used for uplink transmissions from the UE to the relay device. In some aspects, the communications may include the UE receiving or otherwise obtaining an indication of one or more physical layer parameters for a second beam to be used for the communications with the network entity. That is, the one or more physical layer parameters for the second beam may be for the same aircraft (e.g., the first aircraft) or for a different aircraft (e.g., the second aircraft, which may include its own relay device) selected for continued relaying operations between the UE and the network entity. For example, the physical layer parameters may include an indication of a timing advance and frequency compensation for the second beam or may include information used to determine the timing advance and frequency compensation (e., delay and Doppler spread). Accordingly, the UE may switch from the first beam to the second beam according to the one or more physical layer parameters and communicate with the network entity using the second beam (e.g., continue performing relayed communications using the second beam, via the first aircraft or the second aircraft).

Additionally, or alternatively, aspects of the techniques described herein provide for configuration, provisioning, or otherwise determining a common or shared cell identifier (ID) to be used by aircraft communicating with UE within a geographic region. The geographic region may correspond to any of a continent, a country on a continent, a state, province, or territory within a country, a county or area within a state, or a city or municipality within a county. Accordingly, geographic regions are each allocated a unique cell ID to be used by aircraft communicating with UE within the geographic region (either or both of relaying operations where communications between the UE and a network entity are relayed by the aircraft or of strictly UE-to-aircraft communications. For example, a first geographic region may be assigned or otherwise allocated a first cell ID, a second geographic region may be assigned a second cell ID, and so forth. Accordingly, aircraft (e.g., wireless device(s) of the aircraft) may determine that it is operating within a geographic region and select the corresponding cell ID for the geographic region to use for communicating with UE located within the geographic region. The aircraft may also be located within the geographic region or may be operating near the geographic region and communicating with UE located within the geographic region.

A method for wireless communication at a UE is described. The method may include communicating with a network entity via a first relay device of a first aircraft using a first beam associated with the first relay device, receiving via the first relay device of the first aircraft an indication of one or more physical layer parameters associated with a second beam to be used for the communications with the network entity, the second beam associated with the first relay device of the first aircraft or with a second relay device of a second aircraft, switching from the first beam to the second beam in accordance with the one or more physical layer parameters, and communicating with the network entity using the second beam based on the switching.

An apparatus for wireless communication at a UE is described. The apparatus may include a processor, memory coupled with the processor, and instructions stored in the memory. The instructions may be executable by the processor to cause the apparatus to communicate with a network entity via a first relay device of a first aircraft using a first beam associated with the first relay device, receive via the first relay device of the first aircraft an indication of one or more physical layer parameters associated with a second beam to be used for the communications with the network entity, the second beam associated with the first relay device of the first aircraft or with a second relay device of a second aircraft, switch from the first beam to the second beam in accordance with the one or more physical layer parameters, and communicate with the network entity using the second beam based on the switching.

Another apparatus for wireless communication at a UE is described. The apparatus may include means for communicating with a network entity via a first relay device of a first aircraft using a first beam associated with the first relay device, means for receiving via the first relay device of the first aircraft an indication of one or more physical layer parameters associated with a second beam to be used for the communications with the network entity, the second beam associated with the first relay device of the first aircraft or with a second relay device of a second aircraft, means for switching from the first beam to the second beam in accordance with the one or more physical layer parameters, and means for communicating with the network entity using the second beam based on the switching.

A non-transitory computer-readable medium storing code for wireless communication at a UE is described. The code may include instructions executable by a processor to communicate with a network entity via a first relay device of a first aircraft using a first beam associated with the first relay device, receive via the first relay device of the first aircraft an indication of one or more physical layer parameters associated with a second beam to be used for the communications with the network entity, the second beam associated with the first relay device of the first aircraft or with a second relay device of a second aircraft, switch from the first beam to the second beam in accordance with the one or more physical layer parameters, and communicate with the network entity using the second beam based on the switching.

In some examples of the method, apparatuses, and non-transitory computer-readable medium described herein, receiving the indication of the one or more physical layer parameters may include operations, features, means, or instructions for receiving an indication of a timing advance value, a frequency compensation value, or both, for the second beam and switching to the second beam based on the timing advance value, the frequency compensation value, or both.

In some examples of the method, apparatuses, and non-transitory computer-readable medium described herein, receiving the indication of the one or more physical layer parameters may include operations, features, means, or instructions for receiving an indication of a delay value, a Doppler shift value, or both, for the second beam, identifying a timing advance value, a frequency compensation value, or both, for the second beam based on the delay value, the Doppler shift value, or both, and switching to the second beam based on the timing advance value, the frequency compensation value, or both.

In some examples of the method, apparatuses, and non-transitory computer-readable medium described herein, the indication of the one or more physical layer parameters may be received via a radio resource control (RRC) message, a downlink control information (DCI), a medium access control-control element (MAC-CE), a broadcast transmission, a paging message, or any combination thereof.

Some examples of the method, apparatuses, and non-transitory computer-readable medium described herein may further include operations, features, means, or instructions for identifying, based on the indication of one or more physical layer parameters, a delay time between receiving the indication and communicating with the network entity using the second beam, where the switching may be based on the delay time.

In some examples of the method, apparatuses, and non-transitory computer-readable medium described herein, communicating with the network entity via the first relay device of the first aircraft may include operations, features, means, or instructions for transmitting an indication of a location information for the UE to the network entity via the first relay device of the first aircraft, where the second beam may be based on the location information for the UE relative to the first aircraft or to the second aircraft.

Some examples of the method, apparatuses, and non-transitory computer-readable medium described herein may further include operations, features, means, or instructions for determining an identifier associated with the communications between the UE and the network entity via the first relay device of the first aircraft and maintaining the identifier when communicating with the network entity using the second beam via the second relay device of the second aircraft.

A method for wireless communication at a relay device of an aircraft is described. The method may include relaying communications between a UE and a network entity using a first beam associated with the relay device of the aircraft and the UE, identifying one or more physical layer parameters associated with a second beam to be used for relaying communications between the UE and the network entity, the second beam associated with the relay device of the aircraft or with a second relay device of a second aircraft, and transmitting an indication of the one or more physical layer parameters associated with the second beam to the UE.

An apparatus for wireless communication at a relay device of an aircraft is described. The apparatus may include a processor, memory coupled with the processor, and instructions stored in the memory. The instructions may be executable by the processor to cause the apparatus to relay communications between a UE and a network entity using a first beam associated with the relay device of the aircraft and the UE, identify one or more physical layer parameters associated with a second beam to be used for relaying communications between the UE and the network entity, the second beam associated with the relay device of the aircraft or with a second relay device of a second aircraft, and transmit an indication of the one or more physical layer parameters associated with the second beam to the UE.

Another apparatus for wireless communication at a relay device of an aircraft is described. The apparatus may include means for relaying communications between a UE and a network entity using a first beam associated with the relay device of the aircraft and the UE, means for identifying one or more physical layer parameters associated with a second beam to be used for relaying communications between the UE and the network entity, the second beam associated with the relay device of the aircraft or with a second relay device of a second aircraft, and means for transmitting an indication of the one or more physical layer parameters associated with the second beam to the UE.

A non-transitory computer-readable medium storing code for wireless communication at a relay device of an aircraft is described. The code may include instructions executable by a processor to relay communications between a UE and a network entity using a first beam associated with the relay device of the aircraft and the UE, identify one or more physical layer parameters associated with a second beam to be used for relaying communications between the UE and the network entity, the second beam associated with the relay device of the aircraft or with a second relay device of a second aircraft, and transmit an indication of the one or more physical layer parameters associated with the second beam to the UE.

In some examples of the method, apparatuses, and non-transitory computer-readable medium described herein, switching, at the relay device of the aircraft, from the first beam to the second beam in accordance with the one or more physical layer parameters and relaying communications between the UE and the network entity using the second beam associated with the relay device of the aircraft.

In some examples of the method, apparatuses, and non-transitory computer-readable medium described herein, transmitting the indication of the one or more physical layer parameters may include operations, features, means, or instructions for identifying a timing advance value, a frequency compensation value, or both, for the second beam based on a delay value, a Doppler shift value, or both, for the second beam and transmitting an indication of the timing advance value, the frequency compensation value, or both, for the second beam, where the UE switching from the first beam to the second beam may be based on the timing advance value, the frequency compensation value, or both.

In some examples of the method, apparatuses, and non-transitory computer-readable medium described herein, receiving the indication of the one or more physical layer parameters may include operations, features, means, or instructions for identifying a delay value, a Doppler shift value, or both, for the second beam and transmitting an indication of the delay value, the Doppler shift value, or both, for the second beam to the UE.

In some examples of the method, apparatuses, and non-transitory computer-readable medium described herein, the indication of the one or more physical layer parameters may be transmitted via an RRC message, a DCI, a MAC-CE, a broadcast transmission, a paging message, or any combination thereof.

Some examples of the method, apparatuses, and non-transitory computer-readable medium described herein may further include operations, features, means, or instructions for identifying a delay time between the UE receiving the indication and communicating with the network entity using the second beam, where the indication of the one or more physical layer parameters identifies the delay time.

Some examples of the method, apparatuses, and non-transitory computer-readable medium described herein may further include operations, features, means, or instructions for transmitting, to the second relay device of the second aircraft via the network entity or directly via an inter-aircraft link, a location information, a configuration information, a context information, or a combination thereof, for the UE.

Some examples of the method, apparatuses, and non-transitory computer-readable medium described herein may further include operations, features, means, or instructions for receiving an indication of a location information for the UE from the UE and transmitting the location information for the UE to the network entity, where the second beam may be based on the location information for the UE.

Some examples of the method, apparatuses, and non-transitory computer-readable medium described herein may further include operations, features, means, or instructions for determining that a location information for the UE may be unknown and transmitting an indication of an aircraft location information, a first beam configuration and identifier for the first beam, or both, to the network entity, where the second beam may be based on the aircraft location information, the first beam configuration and identifier, or both.

A method for wireless communications at a wireless device of an aircraft is described. The method may include determining that a location of the aircraft is within a first geographic region from a set of geographic regions, each geographic region in the set of geographic regions corresponding to a unique cell identifier used for communications within the geographic region, selecting a first cell identifier corresponding to the first geographic region based on the location of the aircraft, and communicating, while the location of the aircraft is within the first geographic region, with UE located within the first geographic region using the first cell identifier.

An apparatus for wireless communications at a wireless device of an aircraft is described. The apparatus may include a processor, memory coupled with the processor, and instructions stored in the memory. The instructions may be executable by the processor to cause the apparatus to determine that a location of the aircraft is within a first geographic region from a set of geographic regions, each geographic region in the set of geographic regions corresponding to a unique cell identifier used for communications within the geographic region, select a first cell identifier corresponding to the first geographic region based on the location of the aircraft, and communicate, while the location of the aircraft is within the first geographic region, with UE located within the first geographic region using the first cell identifier.

Another apparatus for wireless communications at a wireless device of an aircraft is described. The apparatus may include means for determining that a location of the aircraft is within a first geographic region from a set of geographic regions, each geographic region in the set of geographic regions corresponding to a unique cell identifier used for communications within the geographic region, means for selecting a first cell identifier corresponding to the first geographic region based on the location of the aircraft, and means for communicating, while the location of the aircraft is within the first geographic region, with UE located within the first geographic region using the first cell identifier.

A non-transitory computer-readable medium storing code for wireless communications at a wireless device of an aircraft is described. The code may include instructions executable by a processor to determine that a location of the aircraft is within a first geographic region from a set of geographic regions, each geographic region in the set of geographic regions corresponding to a unique cell identifier used for communications within the geographic region, select a first cell identifier corresponding to the first geographic region based on the location of the aircraft, and communicate, while the location of the aircraft is within the first geographic region, with UE located within the first geographic region using the first cell identifier.

Some examples of the method, apparatuses, and non-transitory computer-readable medium described herein may further include operations, features, means, or instructions for receiving, from a network entity within the first geographic region, an indication of a set of cell identifiers corresponding to the set of geographic regions and selecting the first cell identifier to be used for the communications with the UE from the set of cell identifiers based on the location of the aircraft.

Some examples of the method, apparatuses, and non-transitory computer-readable medium described herein may further include operations, features, means, or instructions for receiving an indication of the first cell identifier from a network entity associated with the first geographic region, where the first cell identifier may be used for communications with the UE based on the receiving.

Some examples of the method, apparatuses, and non-transitory computer-readable medium described herein may further include operations, features, means, or instructions for determining that the aircraft may have moved from the first geographic region to a second geographic region from the set of geographic regions and selecting a second cell identifier corresponding to the second geographic region to use for communications with UE within the second geographic region based on the aircraft moving to the second geographic region.

A method for wireless communications at a network entity is described. The method may include performing relayed communications with a UE via a first relay device of a first aircraft based on a first beam used for relaying communications between the UE and the first relay device, identifying one or more physical layer parameters of a second beam to be used for relaying communications between the UE and the network entity, the second beam associated with a second relay device of a second aircraft, and communicating an indication of the one or more physical layer parameters of the second beam to the UE via the first relay device of the first aircraft.

An apparatus for wireless communications at a network entity is described. The apparatus may include a processor, memory coupled with the processor, and instructions stored in the memory. The instructions may be executable by the processor to cause the apparatus to perform relayed communications with a UE via a first relay device of a first aircraft based on a first beam used for relaying communications between the UE and the first relay device, identify one or more physical layer parameters of a second beam to be used for relaying communications between the UE and the network entity, the second beam associated with a second relay device of a second aircraft, and communicate an indication of the one or more physical layer parameters of the second beam to the UE via the first relay device of the first aircraft.

Another apparatus for wireless communications at a network entity is described. The apparatus may include means for performing relayed communications with a UE via a first relay device of a first aircraft based on a first beam used for relaying communications between the UE and the first relay device, means for identifying one or more physical layer parameters of a second beam to be used for relaying communications between the UE and the network entity, the second beam associated with a second relay device of a second aircraft, and means for communicating an indication of the one or more physical layer parameters of the second beam to the UE via the first relay device of the first aircraft.

A non-transitory computer-readable medium storing code for wireless communications at a network entity is described. The code may include instructions executable by a processor to perform relayed communications with a UE via a first relay device of a first aircraft based on a first beam used for relaying communications between the UE and the first relay device, identify one or more physical layer parameters of a second beam to be used for relaying communications between the UE and the network entity, the second beam associated with a second relay device of a second aircraft, and communicate an indication of the one or more physical layer parameters of the second beam to the UE via the first relay device of the first aircraft.

Some examples of the method, apparatuses, and non-transitory computer-readable medium described herein may further include operations, features, means, or instructions for identifying a delay time between the UE receiving the indication and the UE communicating with the network entity using the second beam, where the indication of the one or more physical layer parameters identifies the delay time.

Some examples of the method, apparatuses, and non-transitory computer-readable medium described herein may further include operations, features, means, or instructions for relaying, from the first aircraft to the second relay device of the second aircraft, a location information, a configuration information, a context information, or a combination thereof, for the UE, where the second beam may be based on the location information, the configuration information, the context information, or the combination thereof.

Some examples of the method, apparatuses, and non-transitory computer-readable medium described herein may further include operations, features, means, or instructions for receiving an indication of a location information for the UE and identifying the second beam based on the location information for the UE.

Some examples of the method, apparatuses, and non-transitory computer-readable medium described herein may further include operations, features, means, or instructions for determining that a location information for the UE may be unknown and identifying the second beam based on an aircraft location information for the first aircraft, a first beam configuration for the first beam, or both.

A method for wireless communications at a network entity is described. The method may include identifying a set of geographic regions, each geographic region in the set of geographic regions corresponding to a unique cell identifier used for communications within the geographic region, where the network entity is located within a first geographic region from the set of geographic regions that corresponds to a first cell identifier and transmitting an indication of the first cell identifier to an aircraft within the first geographic region, where communications between UE and the aircraft use the first cell identifier.

An apparatus for wireless communications at a network entity is described. The apparatus may include a processor, memory coupled with the processor, and instructions stored in the memory. The instructions may be executable by the processor to cause the apparatus to identify a set of geographic regions, each geographic region in the set of geographic regions corresponding to a unique cell identifier used for communications within the geographic region, where the network entity is located within a first geographic region from the set of geographic regions that corresponds to a first cell identifier and transmit an indication of the first cell identifier to an aircraft within the first geographic region, where communications between UE and the aircraft use the first cell identifier.

Another apparatus for wireless communications at a network entity is described. The apparatus may include means for identifying a set of geographic regions, each geographic region in the set of geographic regions corresponding to a unique cell identifier used for communications within the geographic region, where the network entity is located within a first geographic region from the set of geographic regions that corresponds to a first cell identifier and means for transmitting an indication of the first cell identifier to an aircraft within the first geographic region, where communications between UE and the aircraft use the first cell identifier.

A non-transitory computer-readable medium storing code for wireless communications at a network entity is described. The code may include instructions executable by a processor to identify a set of geographic regions, each geographic region in the set of geographic regions corresponding to a unique cell identifier used for communications within the geographic region, where the network entity is located within a first geographic region from the set of geographic regions that corresponds to a first cell identifier and transmit an indication of the first cell identifier to an aircraft within the first geographic region, where communications between UE and the aircraft use the first cell identifier.

In some examples of the method, apparatuses, and non-transitory computer-readable medium described herein, transmitting the indication of the first cell identifier may include operations, features, means, or instructions for transmitting an indication of a set of identifiers corresponding to the set of geographic regions, where the first cell identifier may be used for communications between the UE and the aircraft based on a location of the aircraft within the first geographic region.

Some examples of the method, apparatuses, and non-transitory computer-readable medium described herein may further include operations, features, means, or instructions for determining that the aircraft may be within the first geographic region and transmitting an indication of the first cell identifier to the aircraft based at least part on the aircraft being within the first geographic region.

### BRIEF DESCRIPTION OF THE DRAWINGS

FIG. 1 illustrates an example of a wireless communications system that supports enhancement for aircraft relaying continuity in accordance with one or more aspects of the present disclosure.

FIG. 2 illustrates an example of a wireless communications system that supports enhancement for aircraft relaying continuity in accordance with one or more aspects of the present disclosure.

FIG. 3 illustrates an example of a process that supports enhancement for aircraft relaying continuity in accordance with one or more aspects of the present disclosure.

FIG. 4 illustrates an example of a wireless communications system that supports enhancement for aircraft relaying continuity in accordance with one or more aspects of the present disclosure.

FIG. 5 illustrates an example of a process that supports enhancement for aircraft relaying continuity in accordance with one or more aspects of the present disclosure.

FIG. 6 illustrates an example of a wireless communications system that supports enhancement for aircraft relaying continuity in accordance with one or more aspects of the present disclosure.

FIGS. 7 and 8 show block diagrams of devices that support enhancement for aircraft relaying continuity in accordance with one or more aspects of the present disclosure.

FIG. 9 shows a block diagram of a communications manager that supports enhancement for aircraft relaying continuity in accordance with one or more aspects of the present disclosure.

FIG. 10 shows a diagram of a system including a device that supports enhancement for aircraft relaying continuity in accordance with one or more aspects of the present disclosure.

FIGS. 11 and 12 show block diagrams of devices that support enhancement for aircraft relaying continuity in accordance with one or more aspects of the present disclosure.

FIG. 13 shows a block diagram of a communications manager that supports enhancement for aircraft relaying continuity in accordance with one or more aspects of the present disclosure.

FIG. 14 shows a diagram of a system including a device that supports enhancement for aircraft relaying continuity in accordance with one or more aspects of the present disclosure.

FIGS. 15 through 18 show flowcharts illustrating methods that support enhancement for aircraft relaying continuity in accordance with one or more aspects of the present disclosure.

### DETAILED DESCRIPTION

User equipment (UE) may support performing emergency communications, such as based on an end-user of the UE experiencing an emergency (e.g., such as an accident, being lost, or other emergency condition). Accordingly, aircraft may be configured with one or more relay devices (e.g., wireless communication nodes or devices capable of performing wireless communications) that can relay emergency and non-emergency communications between the UE and a network entity (e.g., to facilitate rescue and recovery of the end-user, support communications between the UE and the network entity, or both). The relayed communications may be performed using beamformed communication techniques, such as using one or more beams. The one or more beams may be based on movement of a single aircraft (e.g., from a first beam to a second beam of the first aircraft) or based on movement of multiple aircraft (e.g., from a first beam of a first aircraft to a second beam of a second aircraft). For example, multiple aircraft may be within range of the UE during takeoff or landing or any time while the aircraft is flying below a threshold altitude. In some examples, multiple aircraft traversing the area may support relaying communications between the UE and the network entity. Wireless networks may support techniques for identifying the next relay aircraft for a given UE (e.g., based on location of the UE and the locations of aircraft traversing the area) to continue enabling relayed communications between the UE and the network entity. However, such networks do not provide a mechanism for configuring the UE for the next relaying beam, whether the second beam (e.g., the next beam to be used for the communications) is for the same aircraft or for another aircraft.

The described techniques provide for signaling physical layer parameter(s) of the next beam to be used for the relaying aircraft. A user equipment (UE) may communicate with a network entity via a first relay device of a first aircraft (e.g., may be performing relayed communications). The relay device may include any device of the aircraft capable of performing or otherwise supporting wireless communications within a wireless network. The relayed communications may be performed using a first beam associated with the first relay device. Broadly, references to a beam may refer to any beam (e.g., transmit beam or receive beam) or beam pair (e.g., transmit beam/receive beam pair) used for downlink transmissions from the relay device to the UE or used for uplink transmissions from the UE to the relay device. In some aspects, the communications may include the UE receiving or otherwise obtaining an indication of one or more physical layer parameters for a second beam to be used for the communications with the network entity. That is, the one or more physical layer parameters for the second beam may be for the same aircraft (e.g., the first aircraft) or for a different aircraft (e.g., the second aircraft, which may include its own relay device) selected for continued relaying operations between the UE and the network entity. For example, the physical layer parameters may include an indication of a timing advance and frequency compensation for the second beam or may include information used to determine the timing advance and frequency compensation (e., delay and Doppler spread). Accordingly, the UE may switch from the first beam to the second beam according to the one or more physical layer parameters and communicate with the network entity using the second beam (e.g., continue performing relayed communications using the second beam, via the first aircraft or the second aircraft).

Additionally, or alternatively, aspects of the techniques described herein provide for configuration, provisioning, or otherwise determining a common or shared cell identifier (ID) to be used by aircraft communicating with UE within a geographic region. The geographic region may correspond to any of a continent, a country on a continent, a state, province, or territory within a country, a county or area within a state, or a city or municipality within a county. Accordingly, geographic regions are each allocated a unique cell ID to be used by aircraft communicating with UE within the geographic region (either or both of relaying operations where communications between the UE and a network entity are relayed by the aircraft or of strictly UE-to-aircraft communications. For example, a first geographic region may be assigned or otherwise allocated a first cell ID, a second geographic region may be assigned a second cell ID, and so forth. Accordingly, aircraft (e.g., wireless device(s) of the aircraft) may determine that it is operating within a geographic region and select the corresponding cell ID for the geographic region to use for communicating with UE located within the geographic region. The aircraft may also be located within the geographic region or may be operating near the geographic region and communicating with UE located within the geographic region.

Aspects of the disclosure are initially described in the context of wireless communications systems. Aspects of the disclosure are further illustrated by and described with reference to apparatus diagrams, system diagrams, and flowcharts that relate to enhancement for aircraft relaying continuity.

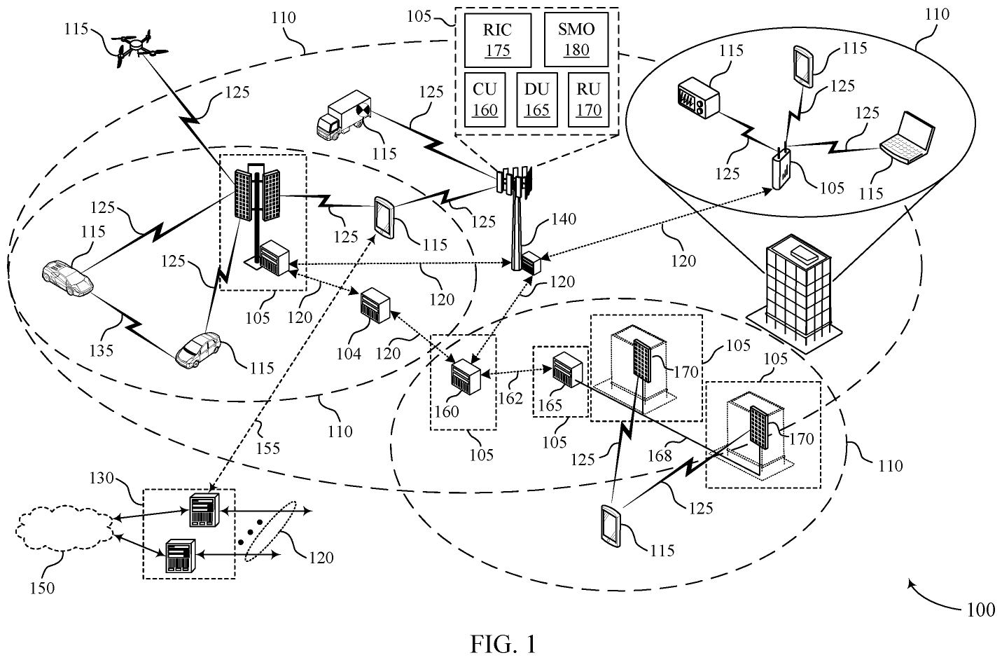

FIG. 1 illustrates an example of a wireless communications system 100 that supports enhancement for aircraft relaying continuity in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support enhancement for aircraft relaying continuity as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may communicate with a network entity 105 via a first relay device of a first aircraft using a first beam associated with the first relay device. The UE 115 may receive via the first relay device of the first aircraft an indication of one or more physical layer parameters associated with a second beam to be used for the communications with the network entity, the second beam associated with the first relay device of the first aircraft or with a second relay device of a second aircraft. The UE 115 may switch from the first beam to the second beam in accordance with the one or more physical layer parameters. The UE 115 may communicate with the network entity 105 using the second beam based at least in part on the switching.

A relay device of an aircraft (e.g., a UE 115 and/or network entity 105 when configured or otherwise supporting wireless communications on an aircraft) may relay communications between a UE 115 and a network entity 105 using a first beam associated with the relay device of the aircraft and the UE 115. The relay device may identify one or more physical layer parameters associated with a second beam to be used for relaying communications between the UE 115 and the network entity 105, the second beam associated with the relay device of the aircraft or with a second relay device of a second aircraft. The relay device may transmit an indication of the one or more physical layer parameters associated with the second beam to the UE 115.

A wireless device of an aircraft (e.g., a UE 115 and/or network entity 105 when configured or otherwise supporting wireless communications on an aircraft) may determine that a location of the aircraft is within a first geographic region from a set of geographic regions, each geographic region in the set of geographic regions corresponding to a unique cell identifier used for communications within the geographic region. The wireless device may select a first cell identifier corresponding to the first geographic region based at least in part on the location of the aircraft. The wireless device may communicate, while the location of the aircraft is within the first geographic region, with UE 115 located within the first geographic region using the first cell identifier.

A network entity 105 may perform relayed communications with a UE 115 via a first relay device of a first aircraft based at least in part on a first beam used for relaying communications between the UE 115 and the first relay device. The network entity 105 may identify one or more physical layer parameters of a second beam to be used for relaying communications between the UE 115 and the network entity 105, the second beam associated with a second relay device of a second aircraft. The network entity 105 may communicate an indication of the one or more physical layer parameters of the second beam to the UE 115 via the first relay device of the first aircraft.

A network entity 105 may identifying a set of geographic regions, each geographic region in the set of geographic regions corresponding to a unique cell identifier used for communications within the geographic region, wherein the network entity 105 is located withing a first geographic region from the set of geographic regions that corresponds to a first cell identifier. The network entity 105 may transmit an indication of the first cell identifier to an aircraft within the first geographic region, wherein communications between UE 115 and the aircraft use the first cell identifier.

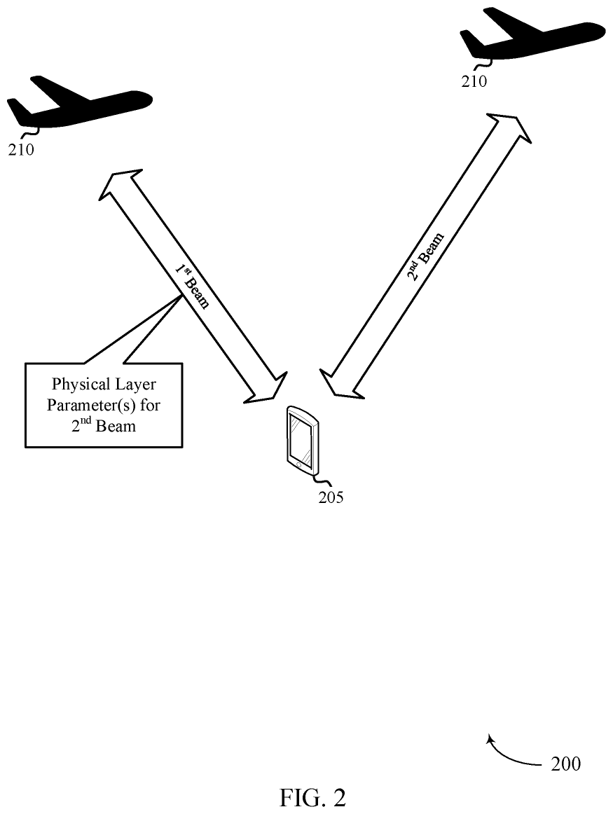

FIG. 2 illustrates an example of a wireless communications system 200 that supports enhancement for aircraft relaying continuity in accordance with one or more aspects of the present disclosure. Wireless communications system 200 may implement aspects of wireless communications system 100.

Wireless communications system 200 may include UE 205 and aircraft 210, which may be examples of the corresponding devices described herein. For example, references to aircraft 210 may refer to a relay device or any wireless device operating on or otherwise associated with an aircraft that is capable of performing wireless communications between the aircraft and a UE (such as UE 205), a network entity, or with other wireless devices. The wireless device of the aircraft may be implemented at or by a UE, at or by a network entity, or at or by both devices. For example, the wireless device may include one or more subcomponents, functions, or features of a network entity implemented on the aircraft, such as a central unit (CU), distributed unit (DU), or other network entity feature or function. The wireless device may support wireless communications between aircraft 210 and a network entity of a terrestrial network (TN) (e.g., a cellular based wireless network) or of a non-terrestrial network (NTN) (e.g., a satellite based cellular wireless network). The wireless device may also be able to perform or otherwise implement wireless communications between aircraft (e.g., inter-aircraft communications). The wireless device may support or otherwise perform wireless communications according to a cellular interface (e.g., Uu interface), a sidelink interface (e.g., PC5 interface), or any other interface used for wireless communications between wireless devices.

Wireless communications system 200 may support air-to-ground (ATG) communications. For example, aircraft 210 may include the wireless device (e.g., implemented as or via a UE function, network entity function, or other function implemented for wireless communications) coupled with one or more antenna on the bottom, sides, or top of aircraft 210. The network entity may support ATG communications using one or more antenna oriented or otherwise tilting upward. Other airborne devices (e.g., aircraft 210) may rely on a customer premise equipment (CPE) deployment to perform such ATG communications.

Various traffic types may be supported for ATG communications. For example, ATG communications may include, but are not limited to, in-flight passenger communications (e.g., commercial traffic), airline operation communications (e.g., flight planning, aircraft maintenance, weather), air traffic control (e.g., as a backup to traditional air traffic control communication systems). Another ATG communication type may include emergency traffic from a UE on the ground (such as SOS signaling when the UE, such as an end-user of the UE, is experience an emergency situation, is lost, and such). Such emergency traffic may include transmitting a relatively small amount of data to support rescue and recovery efforts, such as relying on MTC-type or other small data traffic techniques. However, aircraft are moving such that an aircraft communicating emergency traffic (or any other traffic type, such as relayed communications between the UE and the network entity) will be out of range of the UE relatively quickly. Accordingly, wireless communications system 200 may support aircraft relay continuity where the next aircraft to communicate with the UE is identified based on the location of the UE and the location of the next relaying aircraft. The next aircraft may be identified by the current aircraft communicating with the UE and/or by a network entity managing relayed communications with the UE via aircraft traversing the area. This may enable subsequent communications (e.g., feedback in response to an emergency or SOS transmission) with the UE after the initial relay aircraft departs the area (e.g., is out of range of the UE).

While techniques to identify and configure the next aircraft are supported, conventional techniques do not provide a mechanism to signal physical layer parameter(s) to the UE for the next beam to be used for UE-to-aircraft communications. That is, UE-to-aircraft communications may be performed in a directional manner, such as using one or more beams (e.g., transmit beam, receive beam, or transmit beam/receive beam pair) to increase communication range and/or throughput. Directional communication techniques rely on various physical layer parameters used to determine the communication direction (e.g., the beam) based on the location, direction of travel (e.g., in the four, polar coordinates), speed of travel, angle of travel (e.g., altitude references to up or down), and other physical channel parameters (e.g., propagation features of the channel). The communication direction (e.g., the beam) may also be based on the capabilities or other supported functions of the UE and aircraft. For example, supported antenna configurations, antenna panels, antenna ports, or other analog or digital beamforming techniques may determine how the device may perform beamformed communications using one or more beams. Attempts at ATG communications using directional communication techniques using the wrong beam(s) may result in a total loss of communications between the UE and the aircraft, and the network by extension in some examples. In some emergency conditions, this loss of communications can result in disrupted rescue and recovery efforts for the end-user of the UE.

However, in the situation where the directional communication techniques are applied to communications between the UE and aircraft, beam tracking and management functions may be important given the speed and movement of the aircraft. For example, a UE may be able to communicate with a single aircraft using a first beam. However, movement of the aircraft may result in the aircraft being located in a different direction relative to the UE, such that a second beam may be used for communications between the aircraft and UE when the aircraft is at the second location. However, conventional techniques do not provide a mechanism to indicate information regarding the next beam to be used for communications with the UE. Instead, conventional techniques relay on beam failure recovery (BFR) techniques where the UE must determine that communications with the aircraft using the first beam have failed to satisfy a performance threshold. Accordingly, the UE must perform a beam discovery procedure to find the next beam to be used for communications with the aircraft. This BFR process takes time to perform, which may result in a loss of communication opportunity with the aircraft using the second beam when the aircraft departs the coverage area of the UE before the second beam can be discovered. In some situations, the second location may be associated with a different aircraft (e.g., in relayed aircraft communications), such that the next beam to be used for communications with the UE is associated with the wireless device of the next aircraft.

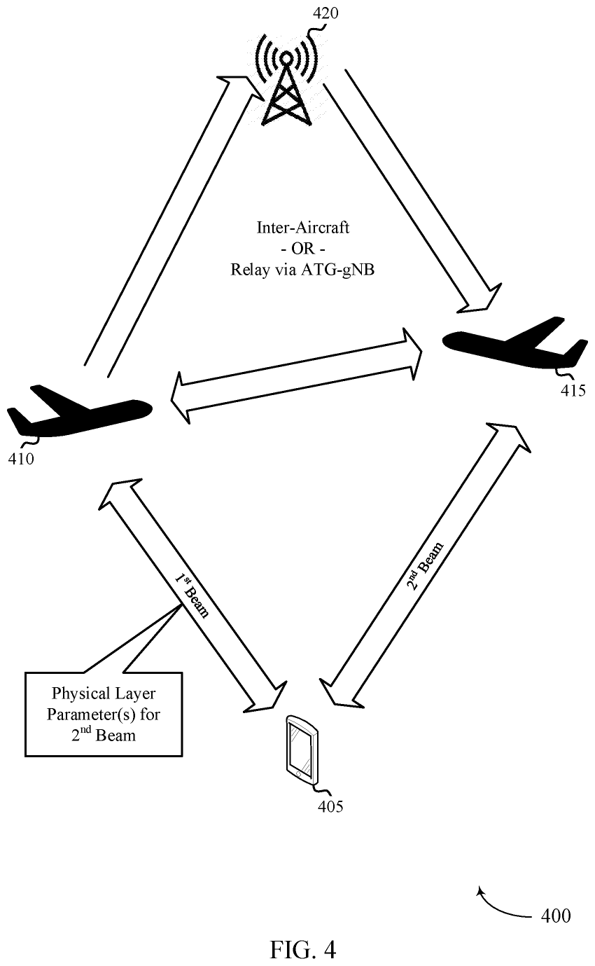

Accordingly, aspects of the techniques described herein provide various techniques for signaling the physical layer parameter(s) of the next beam (e.g., a second beam) to UE 205 so that UE 205 can more quickly tune to the second beam to continue communications with aircraft 210. It is to be understood that the second beam in this context may be a second beam of the same aircraft (e.g., aircraft 210), such as when the aircraft is still within range of UE 205, but is located in a different position relative to UE 205 or the second beam may be for a different aircraft. Wireless communications system 200 illustrates an example where the second beam is associated with the first aircraft and wireless communications system 400 of FIG. 4 illustrates an example where the second beam is associated with a different (e.g., second) aircraft.

Accordingly, UE 205 may be communicating with a network entity via a first relay device (e.g., wireless device) of a first aircraft (e.g., aircraft 210). The communications between UE 205 and aircraft 210 may be performed using a first beam. The first beam may correspond to the directional communication using beamforming techniques. The first beam may include the transmit beam or receive beam of UE 205, the transmit beam or receive beam of aircraft 210, or a transmit beam/receive beam pair between the devices. In some examples, the communications using the first beam may include aircraft 210 transmitting or otherwise conveying an indication of physical layer parameter(s) associated with the second beam to UE 205. That is, the second beam may correspond to the next beam to be used for the communications with the network entity via aircraft 210, in the example shown in FIG. 2. UE 205, aircraft 210, or both may switch to the second beam using the physical layer parameters and UE 205 may communicate with the network entity using the second beam. That is the second beam may be the next beam to be used for ongoing communications between UE 205 and the network entity via aircraft 210. Signaling the physical layer parameters to UE 205 may enable UE 205 to quickly tune, configure, or otherwise implement communications using the second beam to provide continuity for communications between the network entity and UE 205.

The physical layer parameters may generally be based on the expected location of aircraft 210 when communicating using the second beam. For example, aircraft 210 may be moving from a first position to a second position. The first beam may be suited to communications between UE 205 and aircraft 210 when aircraft 210 is located at the first position. As aircraft 210 moves to the second position, the second beam may be better suited to continue communications between UE 205 and aircraft 210. The second position may be identified or otherwise determined based on the location, orientation, speed, or other location information, of aircraft 210, as well as the location of UE 205. The second position may be determined by aircraft 210 or may be determined by the network entity based on aircraft 210 signaling such information to the network entity (e.g., speed, direction, or other location information).

Determination of the second position may permit determination of various physical layer parameters of the second beam. For example, the second position may be relative to the location of the UE, which may define physical layer parameters such as the delay for the second beam, the Doppler shift for the second beam, or both, between UE 205 and aircraft 210 when at the second position. Based on the delay, this may provide an indication of the timing advance to be used for communications between UE 205 and aircraft 210 using the second beam. Based on the Doppler shift, this may provide an indication of the frequency compensation to be used for communications between UE 205 and aircraft 210 using the second beam. That is, the delay and Doppler shift corresponding to the first position may be different than the delay and Doppler shift corresponding to the second position. This may result in different timing advances and frequency compensation values being used for communications using the first beam relative to the second beam. Signaling these physical layer parameters of the second beam to UE 205 during communications using the first beam may enable UE 205 to quickly tune to the second beam when the first beam fails (e.g., without having to perform the BFR process), thus improving continuity of communications between UE 205 and the network entity via aircraft 210.

In some examples, the physical layer parameters signaled to UE 205 may include the timing advance and frequency compensation values for the second beam. For example, aircraft 210 or the network entity may calculate, identify, or otherwise determine the timing advance and frequency compensation values based on the delay and Doppler shift for the second position and transmit or otherwise provide an indication of the timing advance and frequency compensation values for the second beam to UE 205 via aircraft 210. UE 205 and aircraft 210 may both use the timing advance and frequency compensation values to switch to the second beam.

In some examples, the physical layer parameters signaled to UE 205 may include the delay and Doppler shift for the second beam. For example, aircraft 210 or the network entity may calculate or otherwise determine the delay and Doppler shift for the second position based on the aircraft location, direction of travel, speed, angle of travel (e.g., altitude), or other location information, of aircraft 210. Aircraft 210 may transmit or otherwise provide an indication of the delay and Doppler shift for the second beam to UE 205. UE 205 may then use the delay and Doppler shift indicated by aircraft 210 to calculate, identify, or otherwise determine the timing advance and frequency compensation values for the second beam. UE 205 may switch to the second beam based on the timing advance and frequency compensation values.

In some examples, the physical layer parameters signaled to UE 205 may include the information of aircraft 210. For example, aircraft 210 may signal to UE 205 its location, direction of travel, velocity, and so forth. UE 205 may use this information to calculate or otherwise determine the second position (e.g., anticipate the location of aircraft 210), and thus the corresponding delay and Doppler shift for the second beam. UE 205 may use the delay and Doppler shift to calculate, identify, or otherwise determine the timing advance and frequency compensation values for the second beam. UE 205 and aircraft 210 may switch to the second beam based on the timing advance and frequency compensation values.

In some examples, aircraft 210 may use various signaling techniques to indicate the physical layer parameters of the second beam to UE 205. For example, aircraft 210 may use radio resource control (RRC) message(s), a downlink control information (DCI), a medium access control-control element (MAC-CE), a broadcast transmission, or a paging message. For example, if UE 205 is operating in an RRC connected mode, DCI, MAC-CE, or RRC signaling may be used to indicate the physical layer parameters of the second beam to UE 205. If UE 205 is operating in an RRC inactive or idle state, the physical layer parameters of the second beam may be signaled to UE 205 using broadcast or paging signaling. In some aspect, the paging size may impact the paging signal techniques.

In some examples, UE 205 may transmit or otherwise provide an indication of its location information to the network entity via aircraft 210 using the first beam, when available. For example, UE 205 may be configured with various location determination features, functions, or capabilities. One example may include UE 205 storing a last-known location of UE 205 and sending the last-known location as the location information. Another example may include UE 205 being configured with a global navigation satellite system (GNSS) capable of determining the location information of UE 205 using GNSS satellites. Other techniques may be used by UE 205 to identify or otherwise determine the location information of UE 205 (e.g., last used cell ID, last detected Wi-Fi signal, ID of last neighboring UE, or other parameters usable to locate UE 205). Accordingly, the location information for UE 205 may, when known, signaled to aircraft 210 or used by UE 205 when determining the second beam. In other situations, UE 205 may not know its location information or the location information of UE 205 cannot be determined by aircraft 210 or the network entity.

In some aspects, aircraft 210 may transmit or otherwise provide an indication of the location information of UE 205 to the network entity. For example, when the network entity is managing aspects of the communications between UE 205 and aircraft 210, the network entity may identify or otherwise determine the physical layer parameters for the second beam. For example, the network entity may receive an indication of location information and/or physical layer parameters for the second beam from aircraft 210. The network entity may use the location information of UE 205, when known, to identify or otherwise determine the second beam.

For example, the network entity may be communicating with multiple aircraft proximate to UE 205. The network entity may collect the location information of UE 205, when known, as well as location information for each aircraft communicating with UE 205 or that could potentially communicate with UE 205. That is, each aircraft (including aircraft 210, such as when the location information of UE 205 is unknown) may transmit or otherwise provide speed, direction of travel, altitude information, or other location information to the network entity, which may determine the second beam based on the communications with UE 205 using the first beam. In some examples, each aircraft may transmit or otherwise provide their location information to the network entity regularly or in response to an emergency message being received from UE 205. The network entity may use the location information of each aircraft to determine the second position, which may then define the delay and Doppler shift for the second beam. The delay and Doppler shift may be used to find the timing advance and frequency compensation values for the second beam. Accordingly, in some examples the network entity may communicate the physical layer parameters to UE 205 (e.g., via aircraft 210).

In some examples, a common or shared identifier may be used for the communication between UE 205 and the network entity via one or more aircraft. That is, the association between physical aircraft beams and logical cells may be continuously reconfigured so that the same aircraft entity identifier (gNB/integrated access and backhaul (IAB)/UE/relay ID), cell ID and tracking area code (TAC) may be associated with the location of UE 205. For example, the identifier associated with communications between UE 205 and the network entity via a relay aircraft may be maintained when switching to a second beam of a second aircraft. Each aircraft communicating with UE 205 may use the identifier during such communications.

Accordingly, UE 205 and aircraft 210 may switch from the first beam to the second beam for communications with the network entity via aircraft 210 using the physical layer parameters of the second beam signaled to UE 205. This may improve communications via aircraft, such as when providing relayed aircraft continuity to UE 205.

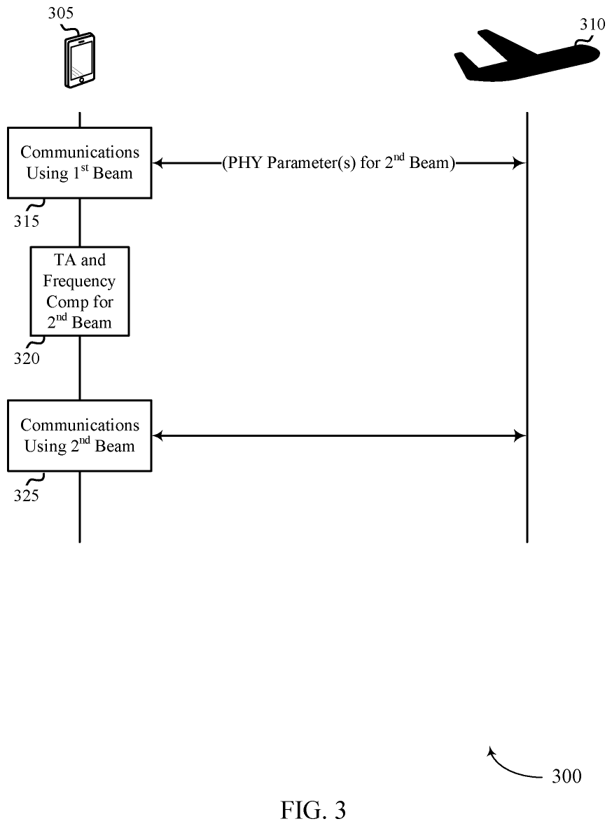

FIG. 3 illustrates an example of a process 300 that supports enhancement for aircraft relaying continuity in accordance with one or more aspects of the present disclosure. Process 300 may implement aspects of wireless communications system 100 or wireless communications system 200. Aspects of process 300 may be implemented at or implemented by UE 305 or aircraft 310, which may be examples of the corresponding devices described herein. For example, references to aircraft 310 may refer to wireless device(s) operating on or otherwise associated with an aircraft that is capable of performing wireless communications between the aircraft and a UE (such as UE 305), a network entity, or with both devices.

At 315, aircraft 310 may transmit or otherwise provide an indication of physical layer parameter(s) of a second beam to UE 305. The indication may be provided using a first beam. For example, UE 305 and aircraft 310 may be performing wireless communications using the first beam. The first beam may correspond to or otherwise be based on the communications between UE 305 and aircraft 310 using directional techniques. The directional techniques may include using the first beam based on the location information of UE 305 and aircraft 310. In some examples, the communications between UE 305 and aircraft 310 may be relaying communications where UE 305 communicates with a network entity via aircraft 310.

At 320, UE 305 identifies or otherwise determines a timing advance and frequency compensation values for a second beam to be used for communications between UE 305 and aircraft 310. That is, due to movement of aircraft 310, the first beam will become unusable for continued communications between UE 305 and aircraft 310. Accordingly, anticipating the future location of aircraft 310 relative to UE 305 may enable identification of the next beam (e.g., the second beam) to be used for directional communications between UE 305 and aircraft 310. The one or more physical layer parameters of the second beam indicated to UE 305 may enable determination of the timing advance and frequency compensation factors for the second beam, which may enable rapid switching from communications using the first beam to communications using the second beam, thus improving continuity of communications for UE 305.

In some examples, the physical layer parameters of the second beam may include an indication of the timing advance and frequency compensation values for the second beam. That is, aircraft 310 or the network entity may identify or otherwise determine the second beam and calculate the timing advance and frequency compensation values for the second beam. The network entity or aircraft 310 may signal the timing advance and frequency compensation values for the second beam to UE 305 using the first beam and UE 305 may switch to the second beam accordingly.

In some examples, the physical layer parameters of the second beam may include an indication of the delay and Doppler shift of the second beam. In this example, UE 305 may use the delay and Doppler shift to determine the timing advance and frequency compensation values of the second beam and switch to the second beam accordingly.

In some examples, the physical layer parameters of the second beam may include an indication of the location information of aircraft 310. For example, the physical layer parameters of the second beam signaled to UE 305 may include the location, speed, direction, or other location information of aircraft 310. UE 305 may use this location information, along with its own location information, to determine the delay and Doppler shift of the second beam. UE 305 may use the delay and Doppler shift to determine the timing advance and frequency compensation values for the second beam and switch to the second beam accordingly.

At 325, UE 305 and aircraft 310 may perform communications using the second beam. For example, UE 305 and aircraft 310 may switch from the first beam to the second beam according to the physical layer parameters signaled to UE 305. The second beam may enable continued communications between UE 305 and aircraft 310 after aircraft 310 has moved to a different location. This may improve continuity of the communication for UE 305. In the example where the communications between UE 305 and aircraft 310 are relayed communications, this may enable continued communications between UE 305 and a network entity via aircraft 310.

FIG. 4 illustrates an example of a wireless communications system 400 that supports enhancement for aircraft relaying continuity in accordance with one or more aspects of the present disclosure. Wireless communications system 200 may implement aspects of wireless communications system 100 or wireless communications system 200 or aspects of process 300.

Wireless communications system 400 may include UE 405 and aircraft 410, aircraft 415, and network entity 420, which may be examples of the corresponding devices described herein. For example, references to any aircraft may refer to a wireless device operating on or otherwise associated with the aircraft that is capable of performing wireless communications between the aircraft and a UE (such as UE 405), a network entity (such as network entity 420), or with other wireless devices. In some examples, network entity 420 may also be considered an ATG communication network (e.g., an ATG-gNB) entity in that network entity 420 is capable of performing wireless communications with one or more aircraft.

Aspects of the techniques described herein provide various techniques for signaling the physical layer parameter(s) of the next beam (e.g., a second beam) to UE 405 so that UE 405 can more quickly tune to the second beam to continue communications via an aircraft. It is to be understood that the second beam in this context may be a second beam of the same aircraft or the second beam may be for a different aircraft. Wireless communications system 200 illustrated an example where the second beam is associated with the first aircraft (e.g., the same aircraft) and wireless communications system 400 of FIG. 4 illustrates an example where the second beam is associated with a different (e.g., second) aircraft (e.g., aircraft 415).

Accordingly, UE 405 may be communicating with network entity 420 via a first relay device (e.g., wireless device) of a first aircraft (e.g., aircraft 410). The communications between UE 405 and aircraft 410 may be performed using a first beam. The first beam may correspond to the directional communication using beamforming techniques. The first beam may include the transmit beam or receive beam of UE 405, the transmit beam or receive beam of aircraft 410, or a transmit beam/receive beam pair between the devices. In some examples, the communications using the first beam may include aircraft 410 transmitting or otherwise conveying an indication of physical layer parameter(s) associated with the second beam to UE 405. That is, the second beam may correspond to the next beam to be used for the communications with the network entity via aircraft 415, in the example shown in FIG. 4. UE 405, aircraft 415, or both may switch to the second beam using the physical layer parameters and UE 405 may communicate with network entity 420 using the second beam via aircraft 415. That is the second beam may be the next beam to be used for ongoing communications between UE 405 and the network entity via an aircraft. Signaling the physical layer parameters to UE 405 may enable UE 405 to quickly tune, configure, or otherwise implement communications using the second beam to provide continuity for communications between network entity 420 and UE 405.

The physical layer parameters may generally be based on the expected location of aircraft 415 when communicating with UE 405 using the second beam. For example, aircraft 410 may be communicating with UE 405 using the first beam based on the location of UE 405 and aircraft 410. The first beam may be suited to communications between UE 405 and aircraft 410 when aircraft 410 is located at the first position. As aircraft 410 moves out of range of UE 405, the next aircraft to be used for communications with UE 405 may be identified and otherwise configured. In the non-limiting example illustrated in FIG. 4, the next aircraft selected for communications with UE 405 may be aircraft 415. That is, based on the location information of UE 405 (when known) and aircraft 415, aircraft 410 or network entity 420 may identify or otherwise determine that aircraft 415 is better suited for continued communications with UE 405. Accordingly, aspects of the techniques described herein provide for exchanging various information used to identify or otherwise determine the second beam.

It is to be understood that exchanging the various information discussed below may be performed inter-aircraft or via network entity 420. That is, in some examples the wireless devices of aircraft 410 and aircraft 415 may be able to communicate directly with each other to exchange the information. In other examples, aircraft 410 may transmit or otherwise provide the information to network entity 420, which may forward the information to aircraft 415. Broadly, the information exchanged between aircraft 410, aircraft 415, and network entity 420, depending on the circumstances, may include location information, configuration information, or context information for UE 405. Although the discussions below regarding the exchange of such information used to determine the second beam for UE 405 are described in the context of the second beam being with a different aircraft, it is to be understood that this information may also be exchanged between the first aircraft and network entity 420 in the situation where the second beam is with the first aircraft, such as shown in FIG. 2.

In some examples, the location information exchanged to enable determination of the second beam may include the position of UE 405 (e.g., such as measured by the first aircraft or as reported by UE 405, when available). In some examples, the information may include various context information, such as an indication of the last received message from UE 405, the last message sent to UE 405, or other identifiable information. In some examples, the configuration information may include the previous L1 configurations/measurements for UE 405 (e.g., reference signal received power (RSRP), angle of arrival (AoA), delay, Doppler shift, modulation and coding scheme (MCS), time domain resource allocation (TDRA), frequency domain resource allocation (FDRA) for the aircraft-to-UE and the UE-to-aircraft links using the first beam for continued relaying using the second beam with the same L1 configuration/measurements by aircraft 415.

In some examples, the information may include identifier(s) of the first aircraft. That is, in some examples an identifier may be associated with the communications between UE 405 and network entity 420 via aircraft 410. For example, the association between the physical aircraft beams and logical cells may be continuously reconfigured so that the same aircraft entity identifier (gNB/IAB/UE/relay ID), cell ID and TAC are always associated with the location where UE 405 is found (e.g., for the communications between UE 405 and network entity 420 via an aircraft).

Accordingly, the information may be exchanged between aircraft 410 and aircraft 415 either directly via the wireless devices of each aircraft or via relaying via network entity 420. The information may be exchanged via a cellular link (e.g., via a Uu interface) using RRC, MAC-CE, or DCI signaling, or via a sidelink (e.g., via a PC5 interface) using RRC, MAC-CE, or sidelink control information (SCI) signaling. When inter-aircraft communications cannot be performed, network entity 420 may forward the information from aircraft 410 to aircraft 415.

Accordingly, the information exchanged may be used to identify or otherwise determine the second beam based on the expected position of aircraft 415. The second beam may be better suited to communications between UE 405 and aircraft 415. Determination of the second position may permit determination of various physical layer parameters of the second beam. Accordingly, UE 405 and aircraft 415 may switch to the second beam for communications with network entity 420 via aircraft 415 using the physical layer parameters of the second beam signaled to UE 405. This may improve communications via aircraft, such as when providing relayed aircraft continuity to UE 405.

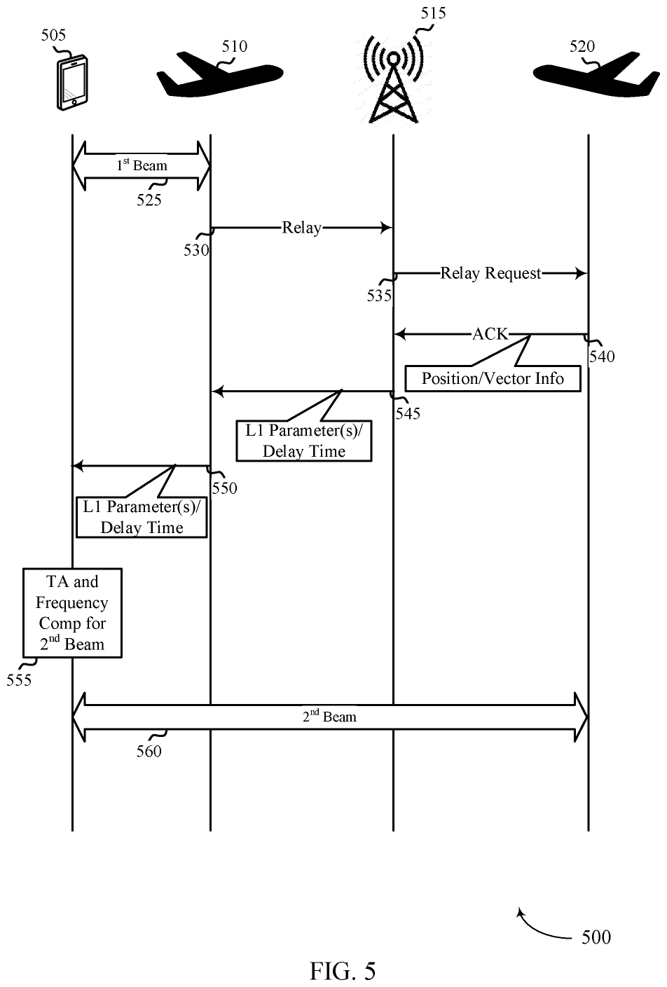

FIG. 5 illustrates an example of a process 500 that supports enhancement for aircraft relaying continuity in accordance with one or more aspects of the present disclosure. Process 500 may implement aspects of wireless communications systems 100, 200 or 400, or aspects of process 300. Aspects of process 500 may be implemented at or implemented by UE 505 or aircraft 510, network entity 515, and aircraft 520, which may be examples of the corresponding devices described herein. For example, references to an aircraft may refer to wireless device(s) operating on or otherwise associated with the aircraft that is capable of performing wireless communications between the aircraft and a UE (such as UE 505), a network entity (such as network entity 515), or with both devices. Process 500 illustrates a non-limiting example where the second beam is associated with a second wireless device of a second aircraft (e.g., aircraft 520 in this example). Although process 500 is described as the situation where network entity 515 is able to relay communications between aircraft 510 and aircraft 520, it is to be understood that in other situations the communications may be direct communications (e.g., inter-aircraft) instead of going through network entity 515.

At 525, UE 505 and aircraft 510 may be performing wireless communications using a first beam. The first beam may refer to the directional communications used for the communications between UE 505 and aircraft 510. In some examples, the communications may include UE 505 transmitting or otherwise providing an indication of its location information to aircraft 510, when available. When the location information of UE 505 is not available, such location information may be determined based on the location of aircraft 510 and the first beam when communicating with UE 505 as well as based on the context/configuration used for the communications between UE 505 and aircraft 510.

At 530, aircraft 510 may transmit or otherwise provide (and network entity 515 may receive or otherwise obtain) relayed communications from UE 505. For example, aircraft 510 may forward one or more messages received from UE 505 to network entity 515 as well as forward the location information of UE 505 and its own location and the first beam information.

At 535, network entity 515 may transmit or otherwise provide (and aircraft 520 may receive or otherwise obtain) a relay request. The relay request may generally signal a request that aircraft 520 is to be the next aircraft to communicate with UE 505 (e.g., that aircraft 520 will be located such that the second beam is best suited for communicating with UE 505). In some examples, the relay request may be a forward of information received from UE 505 via aircraft 510. For example, location information, configuration information, or context information for the communications between UE 505 and aircraft 510 using the first beam may be provided in the relay request. In other examples the relay request may simply indicate a request for the location information of aircraft 520.

At 540, aircraft 520 may transmit or otherwise provide (and network entity 515 may receive or otherwise obtain) an acknowledgement (ACK) message responsive to the relay request. In some examples, the acknowledgement message may confirm that aircraft 520 will communicate with UE 505 as well as include various location information of aircraft 520 (e.g., such as position information, vector information, or other location information).

In the non-limiting example illustrated in FIG. 5, network entity 515 uses the location information of UE 505 and aircraft 520 to identify or otherwise determine the physical layer parameters of the second beam. However, it is to be understood that in some examples aircraft 510 may determine the physical layer parameters of the second beam based on the location information of aircraft 520 received directly or via network entity 515. In other examples, aircraft 520 may determine the physical layer parameters based on the location information of UE 505 and its location information and signal the physical layer parameters to network entity 515 in the acknowledgement message.

Accordingly, at 545 network entity 515 may transmit or otherwise provide (and aircraft 510 may receive or otherwise obtain) and indication of the physical layer (e.g., L1) parameters, such as the timing advance and frequency compensation values, the delay and Doppler shift, of the location information of aircraft 520.

In some examples, there may be a delay time associated with UE 505 communicating using the second beam. For example, aircraft 520 may have yet to arrive at the position corresponding to the second beam. The delay time may generally define the time in which UE 505 receives the indication of the physical layer parameters of the second beam and when UE 505 can communicate using the second beam. In some examples, network entity 515 may include an indication of the delay time to aircraft 510, which may transmit the indication of the delay time to UE 505.

At 550, aircraft 510 may transmit or otherwise provide an indication of physical layer parameter(s) of the second beam to UE 505. The indication may be provided using a first beam. For example, UE 505 and aircraft 510 may be performing wireless communications using the first beam. In some examples, the communications between UE 505 and aircraft 510 may be relaying communications where UE 505 communicates with a network entity 515 via aircraft 510.

At 555, UE 505 identifies or otherwise determines a timing advance and frequency compensation values for a second beam to be used for communications between UE 505 and aircraft 520. The one or more physical layer parameters of the second beam indicated to UE 505 may enable determination of the timing advance and frequency compensation factors for the second beam, which may enable rapid switching from communications with aircraft 510 using the first beam to communications with aircraft 520 using the second beam, thus improving continuity of communications for UE 505.

At 560, UE 505 and aircraft 520 may perform communications using the second beam. For example, UE 505 and aircraft 520 may switch to the second beam according to the physical layer parameters signaled to UE 505. The second beam may enable continued communications between UE 505 and network entity 515 via aircraft 520. This may improve continuity of the communication for UE 505. In the example where the communications between UE 505 and aircraft 520 are relayed communications, this may enable continued communications between UE 505 and network entity 515 via aircraft 520.

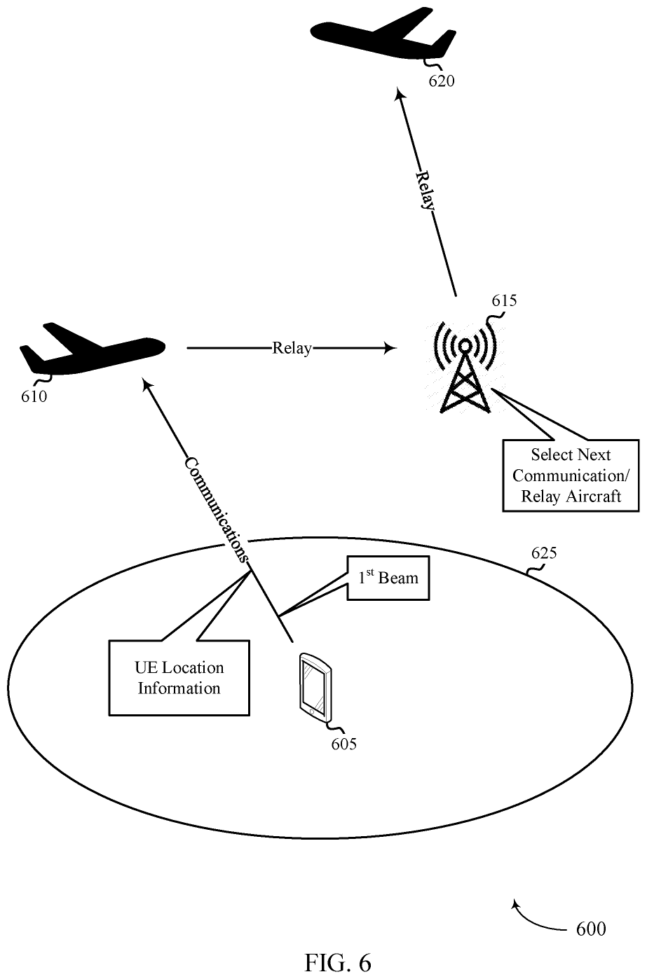

FIG. 6 illustrates an example of a wireless communications system 600 that supports enhancement for aircraft relaying continuity in accordance with one or more aspects of the present disclosure. Wireless communications system 600 may implement aspects of wireless communications systems 100, 200, or 400, or aspects of process 300 or process 500.

Wireless communications system 600 may include UE 605 and aircraft 610, network entity 615, and aircraft 620, which may be examples of the corresponding devices described herein. For example, references to any aircraft may refer to a wireless device operating on or otherwise associated with the aircraft that is capable of performing wireless communications between the aircraft and a UE (such as UE 605), a network entity (such as network entity 615), or with other wireless devices. In some examples, network entity 615 may also be considered an ATG communication network (e.g., an ATG-gNB) entity in that network entity 615 is capable of performing wireless communications with one or more aircraft.

Aspects of the techniques described herein provide various techniques for signaling the physical layer parameter(s) of the next beam (e.g., a second beam) to UE 605 so that UE 605 can more quickly tune to the second beam to continue communications via an aircraft. It is to be understood that the second beam in this context may be a second beam of the same aircraft or the second beam may be for a different aircraft. Wireless communications system 200 illustrated an example where the second beam is associated with the first aircraft (e.g., the same aircraft) and wireless communications systems 400 of FIG. 4 and 600 of FIG. 6 illustrate examples where the second beam is associated with a different (e.g., second) aircraft (e.g., aircraft 620).

Accordingly, UE 605 may be communicating with network entity 615 via a first relay device (e.g., wireless device) of a first aircraft (e.g., aircraft 610). The communications between UE 605 and aircraft 610 may be performed using a first beam.

In some examples, the communications using the first beam may include aircraft 610 transmitting or otherwise conveying an indication of physical layer parameter(s) associated with the second beam to UE 605. That is, the second beam may correspond to the next beam to be used for the communications with the network entity via aircraft 620, in the example shown in FIG. 6. UE 605, aircraft 620, or both may switch to the second beam using the physical layer parameters and UE 605 may communicate with network entity 615 using the second beam via aircraft 620. That is the second beam may be the next beam to be used for ongoing communications between UE 605 and the network entity via an aircraft. Signaling the physical layer parameters to UE 605 may enable UE 605 to quickly tune, configure, or otherwise implement communications using the second beam to provide continuity for communications between network entity 615 and UE 605.

As discussed above, exchanging various information discussed herein may be performed inter-aircraft or via network entity 615. That is, in some examples the wireless devices of aircraft 610 and aircraft 620 may be able to communicate directly with each other to exchange the information. In other examples, aircraft 610 may transmit or otherwise provide the information to network entity 615, which may forward the information to aircraft 620. Broadly, the information exchanged between aircraft 610, aircraft 620, and network entity 615, depending on the circumstances, may include location information, configuration information, or context information for UE 605.

In some examples, the location information exchanged to enable determination of the second beam may include the position of UE 605 (e.g., such as measured by the first aircraft or as reported by UE 605, when available). In some examples, the information may include identifier(s) of the first aircraft. That is, in some examples an identifier may be associated with the communications between UE 605 and network entity 615 via aircraft 610. For example, the association between the physical aircraft beams and logical cells may be continuously reconfigured so that the same aircraft entity identifier (gNB/IAB/UE/relay ID), cell ID and TAC are always associated with the location where UE 605 is found (e.g., for the communications between UE 605 and network entity 615 via an aircraft).

Accordingly, the information may be exchanged between aircraft 610 and aircraft 620 either directly via the wireless devices of each aircraft or via relaying via network entity 615. The information may be exchanged via a cellular link (e.g., via a Uu interface) using RRC, MAC-CE, or DCI signaling, or via a sidelink (e.g., via a PC5 interface) using RRC, MAC-CE, or SCI signaling. When inter-aircraft communications cannot be performed, network entity 615 may forward the information from aircraft 610 to aircraft 620.

Accordingly, the information exchanged may be used to identify or otherwise determine the second beam based on the expected position of aircraft 620. The second beam may be better suited to communications between UE 605 and aircraft 620. Determination of the second position may permit determination of various physical layer parameters of the second beam. Accordingly, UE 605 and aircraft 620 may switch to the second beam for communications with network entity 615 via aircraft 620 using the physical layer parameters of the second beam signaled to UE 605. This may improve communications via aircraft, such as when providing relayed aircraft continuity to UE 605.

In some aspects, selection of the next relaying aircraft may be based on an area 625. For example, a zone may be defined corresponding to area 625. For example, the zone may generally define the are in which communications with UE 605 may be performed. Network entity 615 may, based on the zone, determine that aircraft 620 is the aircraft within the zone that is best suited for continued communications with UE 605 (e.g., based on the location information of aircraft 620 relative to the location information of UE 605). In some examples, each aircraft operating within the zone may be assigned a priority level, with network entity 615 selecting aircraft 620 based on the priority level of aircraft 620. For example, the priority level of a given aircraft may be based on a variety of factors, such as the communication capability of the wireless device of aircraft 620, the distance between the potential aircraft and UE 605, or other location information. In some examples, a zone identifier may be assigned to the zone and signaled to the aircraft performing communications with UE 605.

In some examples, the area 625 may correspond to a first geographic region. That is, in some examples the area 625 may correspond to a first geographic region that is configured with a first cell identifier.

Additionally, or alternatively, to the techniques discussed above regarding signaling the physical layer parameters of the second beam to UE 605, the present disclosure further provides for one or more geographic regions being allocated a unique identifier to be used by aircraft operating within the geographic region. Each aircraft operating within a given geographic region may select the cell identifier (e.g., the unique identifier) configured for the geographic region and use this identifier when communicating with UE located within the geographic region. In some examples, the area 625 may correspond to a first geographic region that is configured with a first cell identifier.

More particularly, additionally, or alternatively, aspects of the techniques described herein provide for configuration, provisioning, or otherwise determining a common or shared cell identifier to be used by aircraft communicating with UE within a geographic region. The geographic region may correspond to any of a continent, a country on a continent, a state, province, or territory within a country, a county or area within a state, or a city or municipality within a county. Accordingly, geographic regions are each allocated a unique cell identifier to be used by aircraft communicating with UE within the geographic region (either or both of relaying operations where communications between the UE and a network entity are relayed by the aircraft or of strictly communications between the UE and the aircraft. For example, a first geographic region may be assigned or otherwise allocated a first cell identifier, a second geographic region may be assigned a second cell identifier, and so forth. Accordingly, aircraft (e.g., wireless device(s) of the aircraft) may determine that it is operating within a geographic region and select the corresponding cell identifier for the geographic region to use for communicating with UE located within the geographic region. The aircraft may also be located within the geographic region or may be operating near the geographic region and communicating with UE located within the geographic region.

In some examples, this may support a global varying aircraft cell identifier. The aircraft may adopt different cell identifiers when in different geographic regions (e.g., in different countries or regions). In some examples, the cell identifier for a particular region may include a NR Cell Global Identifier (NCGI) that is formed based on the public land mobile network (PLMN) identifier and the NC cell identifier (NCI). The PLMN identifier may change when the operator changes due to being in different geographic regions. The NCI may change with smaller scales (e.g., all aircraft may use the same identifier when operating in a particular zone.

In some aspects, an aircraft changing the cell identifier based on the geographic region may be triggered by different signaling techniques. One technique may include the aircraft being (pre) configured with a list of cell identifiers (e.g., a set of cell identifiers) corresponding to different geographic regions. An aircraft entering a new geographic region may simply adopt the cell identifier of the geographic region using the list of cell identifiers. Another technique may include the aircraft being signaled with the cell identifier. For example, with or without being signaled with the set of cell identifiers, the aircraft may receive an indication of the cell identifier (such as from an access and management function (AMF) or other entity in the core network) via a network entity (such as network entity 615). The aircraft being signaled with the cell identifier may serve as the trigger for the aircraft to switch to the signaled cell identifier for communications with UE located within the geographic region. Further, aircraft transitioning from one geographic region to a different geographic region may adopt the cell identifier of the new geographic region (e.g., a second cell identifier based on moving into a second geographic region).

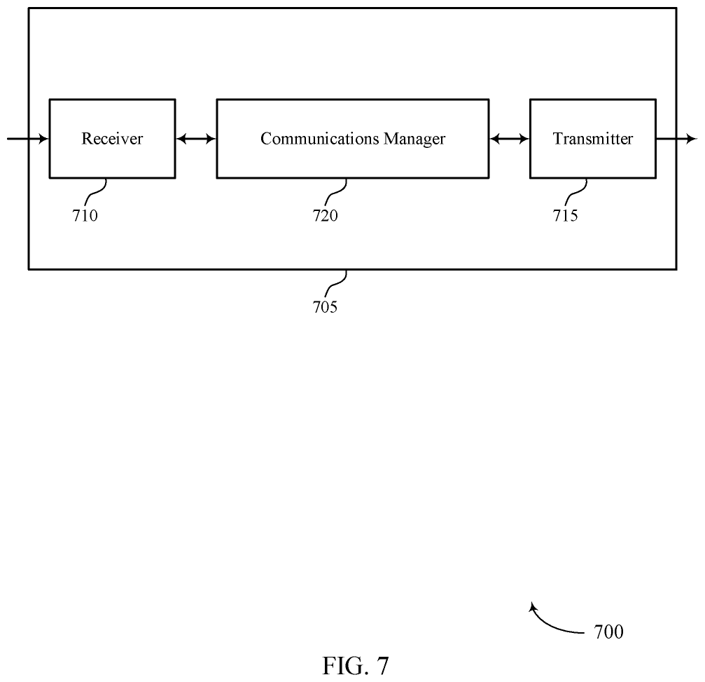

FIG. 7 shows a block diagram 700 of a device 705 that supports enhancement for aircraft relaying continuity in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to enhancement for aircraft relaying continuity). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to enhancement for aircraft relaying continuity). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of enhancement for aircraft relaying continuity as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry), in software (e.g., executed by a processor), or any combination thereof. The hardware may include a processor, a digital signal processor (DSP), a central processing unit (CPU), a graphic processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software) executed by a processor. If implemented in code executed by a processor, the functions of the communications manager 720, the receiver 710, the transmitter 715, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for communicating with a network entity via a first relay device of a first aircraft using a first beam associated with the first relay device. The communications manager 720 may be configured as or otherwise support a means for receiving via the first relay device of the first aircraft an indication of one or more physical layer parameters associated with a second beam to be used for the communications with the network entity, the second beam associated with the first relay device of the first aircraft or with a second relay device of a second aircraft. The communications manager 720 may be configured as or otherwise support a means for switching from the first beam to the second beam in accordance with the one or more physical layer parameters. The communications manager 720 may be configured as or otherwise support a means for communicating with the network entity using the second beam based on the switching.

Additionally, or alternatively, the communications manager 720 may support wireless communication at a relay device of an aircraft in accordance with examples as disclosed herein. For example, the communications manager 720 may be configured as or otherwise support a means for relaying communications between a UE and a network entity using a first beam associated with the relay device of the aircraft and the UE. The communications manager 720 may be configured as or otherwise support a means for identifying one or more physical layer parameters associated with a second beam to be used for relaying communications between the UE and the network entity, the second beam associated with the relay device of the aircraft or with a second relay device of a second aircraft. The communications manager 720 may be configured as or otherwise support a means for transmitting an indication of the one or more physical layer parameters associated with the second beam to the UE.

Additionally, or alternatively, the communications manager 720 may support wireless communications at a wireless device of an aircraft in accordance with examples as disclosed herein. For example, the communications manager 720 may be configured as or otherwise support a means for determining that a location of the aircraft is within a first geographic region from a set of geographic regions, each geographic region in the set of geographic regions corresponding to a unique cell identifier used for communications within the geographic region. The communications manager 720 may be configured as or otherwise support a means for selecting a first cell identifier corresponding to the first geographic region based on the location of the aircraft. The communications manager 720 may be configured as or otherwise support a means for communicating, while the location of the aircraft is within the first geographic region, with UE located within the first geographic region using the first cell identifier.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for signaling physical layer parameters for the next beam to a UE to improve communications between the UE and an aircraft.

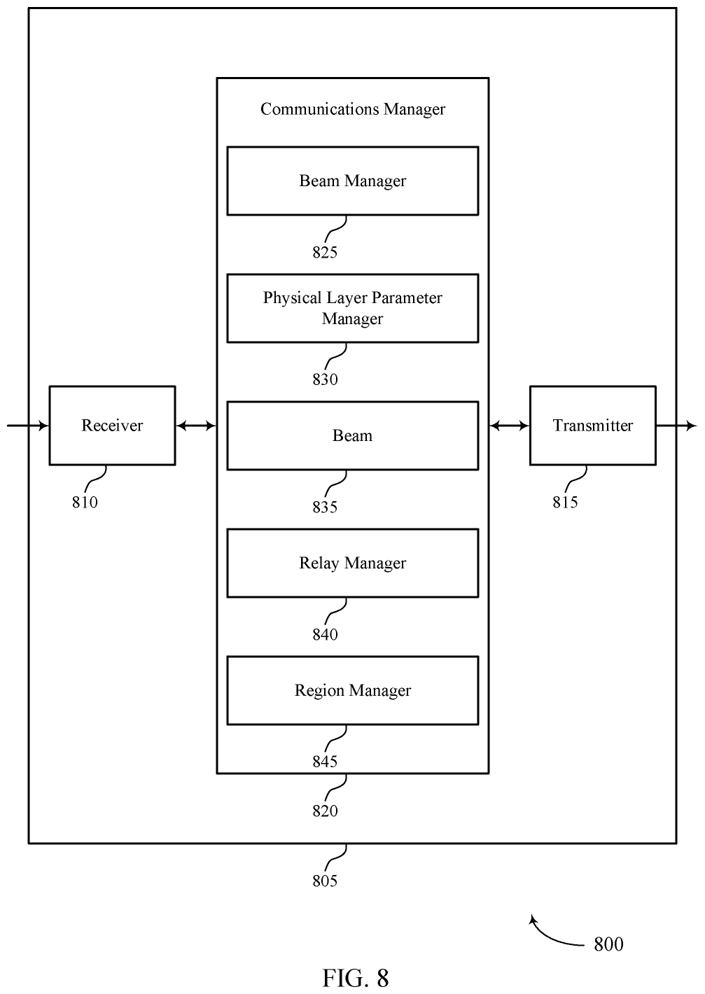

FIG. 8 shows a block diagram 800 of a device 805 that supports enhancement for aircraft relaying continuity in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to enhancement for aircraft relaying continuity). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to enhancement for aircraft relaying continuity). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of enhancement for aircraft relaying continuity as described herein. For example, the communications manager 820 may include a beam manager 825, a physical layer parameter manager 830, a beam 835, a relay manager 840, a region manager 845, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The beam manager 825 may be configured as or otherwise support a means for communicating with a network entity via a first relay device of a first aircraft using a first beam associated with the first relay device. The physical layer parameter manager 830 may be configured as or otherwise support a means for receiving via the first relay device of the first aircraft an indication of one or more physical layer parameters associated with a second beam to be used for the communications with the network entity, the second beam associated with the first relay device of the first aircraft or with a second relay device of a second aircraft. The beam 835 may be configured as or otherwise support a means for switching from the first beam to the second beam in accordance with the one or more physical layer parameters. The beam manager 825 may be configured as or otherwise support a means for communicating with the network entity using the second beam based on the switching.

Additionally, or alternatively, the communications manager 820 may support wireless communication at a relay device of an aircraft in accordance with examples as disclosed herein. The relay manager 840 may be configured as or otherwise support a means for relaying communications between a UE and a network entity using a first beam associated with the relay device of the aircraft and the UE. The physical layer parameter manager 830 may be configured as or otherwise support a means for identifying one or more physical layer parameters associated with a second beam to be used for relaying communications between the UE and the network entity, the second beam associated with the relay device of the aircraft or with a second relay device of a second aircraft. The physical layer parameter manager 830 may be configured as or otherwise support a means for transmitting an indication of the one or more physical layer parameters associated with the second beam to the UE.

Additionally, or alternatively, the communications manager 820 may support wireless communications at a wireless device of an aircraft in accordance with examples as disclosed herein. The region manager 845 may be configured as or otherwise support a means for determining that a location of the aircraft is within a first geographic region from a set of geographic regions, each geographic region in the set of geographic regions corresponding to a unique cell identifier used for communications within the geographic region. The region manager 845 may be configured as or otherwise support a means for selecting a first cell identifier corresponding to the first geographic region based on the location of the aircraft. The region manager 845 may be configured as or otherwise support a means for communicating, while the location of the aircraft is within the first geographic region, with UE located within the first geographic region using the first cell identifier.

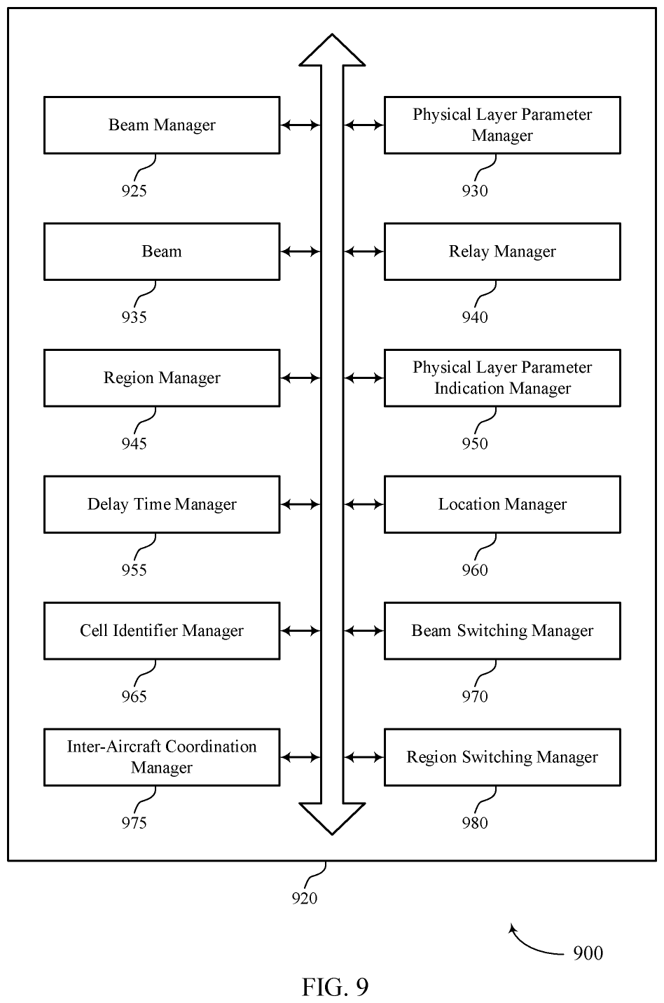

FIG. 9 shows a block diagram 900 of a communications manager 920 that supports enhancement for aircraft relaying continuity in accordance with one or more aspects of the present disclosure. The communications manager 920 may be an example of aspects of a communications manager 720, a communications manager 820, or both, as described herein. The communications manager 920, or various components thereof, may be an example of means for performing various aspects of enhancement for aircraft relaying continuity as described herein. For example, the communications manager 920 may include a beam manager 925, a physical layer parameter manager 930, a beam 935, a relay manager 940, a region manager 945, a physical layer parameter indication manager 950, a delay time manager 955, a location manager 960, a cell identifier manager 965, a beam switching manager 970, an inter-aircraft coordination manager 975, a region switching manager 980, or any combination thereof. Each of these components may communicate, directly or indirectly, with one another (e.g., via one or more buses).

The communications manager 920 may support wireless communication at a UE in accordance with examples as disclosed herein. The beam manager 925 may be configured as or otherwise support a means for communicating with a network entity via a first relay device of a first aircraft using a first beam associated with the first relay device. The physical layer parameter manager 930 may be configured as or otherwise support a means for receiving via the first relay device of the first aircraft an indication of one or more physical layer parameters associated with a second beam to be used for the communications with the network entity, the second beam associated with the first relay device of the first aircraft or with a second relay device of a second aircraft. The beam 935 may be configured as or otherwise support a means for switching from the first beam to the second beam in accordance with the one or more physical layer parameters. In some examples, the beam manager 925 may be configured as or otherwise support a means for communicating with the network entity using the second beam based on the switching.

In some examples, to support receiving the indication of the one or more physical layer parameters, the physical layer parameter indication manager 950 may be configured as or otherwise support a means for receiving an indication of a timing advance value, a frequency compensation value, or both, for the second beam. In some examples, to support receiving the indication of the one or more physical layer parameters, the physical layer parameter indication manager 950 may be configured as or otherwise support a means for switching to the second beam based on the timing advance value, the frequency compensation value, or both.

In some examples, to support receiving the indication of the one or more physical layer parameters, the physical layer parameter indication manager 950 may be configured as or otherwise support a means for receiving an indication of a delay value, a Doppler shift value, or both, for the second beam. In some examples, to support receiving the indication of the one or more physical layer parameters, the physical layer parameter indication manager 950 may be configured as or otherwise support a means for identifying a timing advance value, a frequency compensation value, or both, for the second beam based on the delay value, the Doppler shift value, or both. In some examples, to support receiving the indication of the one or more physical layer parameters, the physical layer parameter indication manager 950 may be configured as or otherwise support a means for switching to the second beam based on the timing advance value, the frequency compensation value, or both.

In some examples, the indication of the one or more physical layer parameters is received via an RRC message, a DCI, a medium access control-control element (MAC-CE), a broadcast transmission, a paging message, or any combination thereof.

In some examples, the delay time manager 955 may be configured as or otherwise support a means for identifying, based on the indication of one or more physical layer parameters, a delay time between receiving the indication and communicating with the network entity using the second beam, where the switching is based on the delay time.

In some examples, to support communicating with the network entity via the first relay device of the first aircraft, the location manager 960 may be configured as or otherwise support a means for transmitting an indication of a location information for the UE to the network entity via the first relay device of the first aircraft, where the second beam is based on the location information for the UE relative to the first aircraft or to the second aircraft.

In some examples, the cell identifier manager 965 may be configured as or otherwise support a means for determining an identifier associated with the communications between the UE and the network entity via the first relay device of the first aircraft. In some examples, the cell identifier manager 965 may be configured as or otherwise support a means for maintaining the identifier when communicating with the network entity using the second beam via the second relay device of the second aircraft.

Additionally, or alternatively, the communications manager 920 may support wireless communication at a relay device of an aircraft in accordance with examples as disclosed herein. The relay manager 940 may be configured as or otherwise support a means for relaying communications between a UE and a network entity using a first beam associated with the relay device of the aircraft and the UE. In some examples, the physical layer parameter manager 930 may be configured as or otherwise support a means for identifying one or more physical layer parameters associated with a second beam to be used for relaying communications between the UE and the network entity, the second beam associated with the relay device of the aircraft or with a second relay device of a second aircraft. In some examples, the physical layer parameter manager 930 may be configured as or otherwise support a means for transmitting an indication of the one or more physical layer parameters associated with the second beam to the UE.

In some examples, the beam switching manager 970 may be configured as or otherwise support a means for switching, at the relay device of the aircraft, from the first beam to the second beam in accordance with the one or more physical layer parameters. In some examples, the beam switching manager 970 may be configured as or otherwise support a means for relaying communications between the UE and the network entity using the second beam associated with the relay device of the aircraft.

In some examples, to support transmitting the indication of the one or more physical layer parameters, the physical layer parameter indication manager 950 may be configured as or otherwise support a means for identifying a timing advance value, a frequency compensation value, or both, for the second beam based on a delay value, a Doppler shift value, or both, for the second beam. In some examples, to support transmitting the indication of the one or more physical layer parameters, the physical layer parameter indication manager 950 may be configured as or otherwise support a means for transmitting an indication of the timing advance value, the frequency compensation value, or both, for the second beam, where the UE switching from the first beam to the second beam is based on the timing advance value, the frequency compensation value, or both.

In some examples, to support receiving the indication of the one or more physical layer parameters, the physical layer parameter indication manager 950 may be configured as or otherwise support a means for identifying a delay value, a Doppler shift value, or both, for the second beam. In some examples, to support receiving the indication of the one or more physical layer parameters, the physical layer parameter indication manager 950 may be configured as or otherwise support a means for transmitting an indication of the delay value, the Doppler shift value, or both, for the second beam to the UE.

In some examples, the indication of the one or more physical layer parameters is transmitted via an RRC message, a DCI, a medium access control-control element (MAC-CE), a broadcast transmission, a paging message, or any combination thereof.

In some examples, the delay time manager 955 may be configured as or otherwise support a means for identifying a delay time between the UE receiving the indication and communicating with the network entity using the second beam, where the indication of the one or more physical layer parameters identifies the delay time.

In some examples, the inter-aircraft coordination manager 975 may be configured as or otherwise support a means for transmitting, to the second relay device of the second aircraft via the network entity or directly via an inter-aircraft link, a location information, a configuration information, a context information, or a combination thereof, for the UE.

In some examples, the location manager 960 may be configured as or otherwise support a means for receiving an indication of a location information for the UE from the UE. In some examples, the location manager 960 may be configured as or otherwise support a means for transmitting the location information for the UE to the network entity, where the second beam is based on the location information for the UE.

In some examples, the location manager 960 may be configured as or otherwise support a means for determining that a location information for the UE is unknown. In some examples, the location manager 960 may be configured as or otherwise support a means for transmitting an indication of an aircraft location information, a first beam configuration and identifier for the first beam, or both, to the network entity, where the second beam is based on the aircraft location information, the first beam configuration and identifier, or both.

Additionally, or alternatively, the communications manager 920 may support wireless communications at a wireless device of an aircraft in accordance with examples as disclosed herein. The region manager 945 may be configured as or otherwise support a means for determining that a location of the aircraft is within a first geographic region from a set of geographic regions, each geographic region in the set of geographic regions corresponding to a unique cell identifier used for communications within the geographic region. In some examples, the region manager 945 may be configured as or otherwise support a means for selecting a first cell identifier corresponding to the first geographic region based on the location of the aircraft. In some examples, the region manager 945 may be configured as or otherwise support a means for communicating, while the location of the aircraft is within the first geographic region, with UE located within the first geographic region using the first cell identifier.

In some examples, the cell identifier manager 965 may be configured as or otherwise support a means for receiving, from a network entity within the first geographic region, an indication of a set of cell identifiers corresponding to the set of geographic regions. In some examples, the cell identifier manager 965 may be configured as or otherwise support a means for selecting the first cell identifier to be used for the communications with the UE from the set of cell identifiers based on the location of the aircraft.

In some examples, the cell identifier manager 965 may be configured as or otherwise support a means for receiving an indication of the first cell identifier from a network entity associated with the first geographic region, where the first cell identifier is used for communications with the UE based on the receiving.

In some examples, the region switching manager 980 may be configured as or otherwise support a means for determining that the aircraft has moved from the first geographic region to a second geographic region from the set of geographic regions. In some examples, the region switching manager 980 may be configured as or otherwise support a means for selecting a second cell identifier corresponding to the second geographic region to use for communications with UE within the second geographic region based on the aircraft moving to the second geographic region.

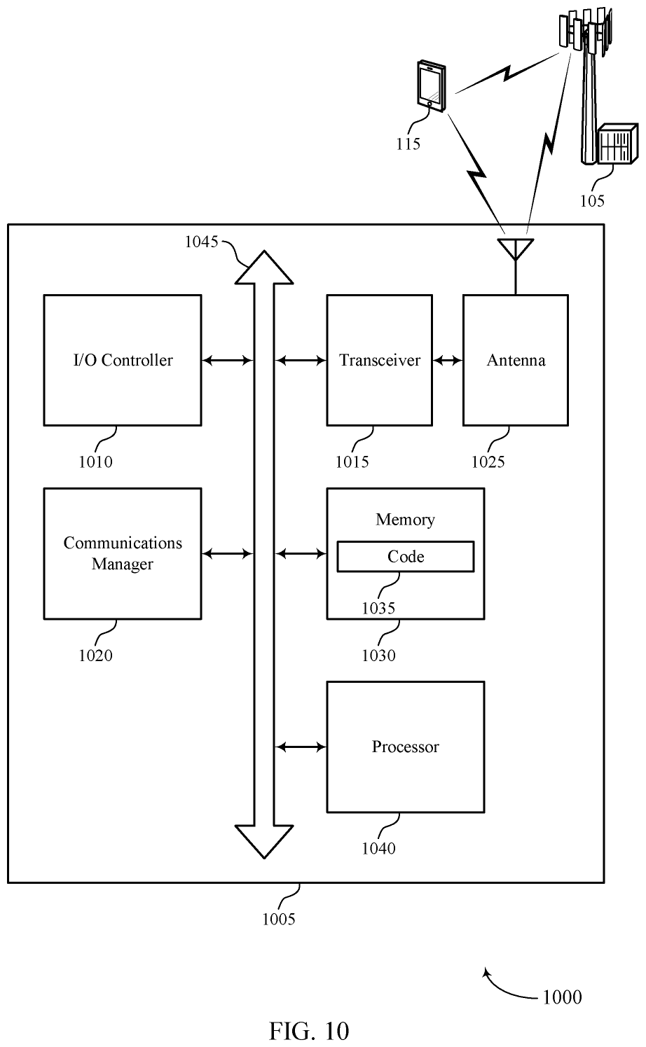

FIG. 10 shows a diagram of a system 1000 including a device 1005 that supports enhancement for aircraft relaying continuity in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting enhancement for aircraft relaying continuity). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for communicating with a network entity via a first relay device of a first aircraft using a first beam associated with the first relay device. The communications manager 1020 may be configured as or otherwise support a means for receiving via the first relay device of the first aircraft an indication of one or more physical layer parameters associated with a second beam to be used for the communications with the network entity, the second beam associated with the first relay device of the first aircraft or with a second relay device of a second aircraft. The communications manager 1020 may be configured as or otherwise support a means for switching from the first beam to the second beam in accordance with the one or more physical layer parameters. The communications manager 1020 may be configured as or otherwise support a means for communicating with the network entity using the second beam based on the switching.

Additionally, or alternatively, the communications manager 1020 may support wireless communication at a relay device of an aircraft in accordance with examples as disclosed herein. For example, the communications manager 1020 may be configured as or otherwise support a means for relaying communications between a UE and a network entity using a first beam associated with the relay device of the aircraft and the UE. The communications manager 1020 may be configured as or otherwise support a means for identifying one or more physical layer parameters associated with a second beam to be used for relaying communications between the UE and the network entity, the second beam associated with the relay device of the aircraft or with a second relay device of a second aircraft. The communications manager 1020 may be configured as or otherwise support a means for transmitting an indication of the one or more physical layer parameters associated with the second beam to the UE.

Additionally, or alternatively, the communications manager 1020 may support wireless communications at a wireless device of an aircraft in accordance with examples as disclosed herein. For example, the communications manager 1020 may be configured as or otherwise support a means for determining that a location of the aircraft is within a first geographic region from a set of geographic regions, each geographic region in the set of geographic regions corresponding to a unique cell identifier used for communications within the geographic region. The communications manager 1020 may be configured as or otherwise support a means for selecting a first cell identifier corresponding to the first geographic region based on the location of the aircraft. The communications manager 1020 may be configured as or otherwise support a means for communicating, while the location of the aircraft is within the first geographic region, with UE located within the first geographic region using the first cell identifier.

By including or configuring the communications manager 1020 in accordance with examples as described herein, the device 1005 may support techniques for signaling physical layer parameters for the next beam to a UE to improve communications between the UE and an aircraft.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of enhancement for aircraft relaying continuity as described herein, or the processor 1040 and the memory 1030 may be otherwise configured to perform or support such operations.

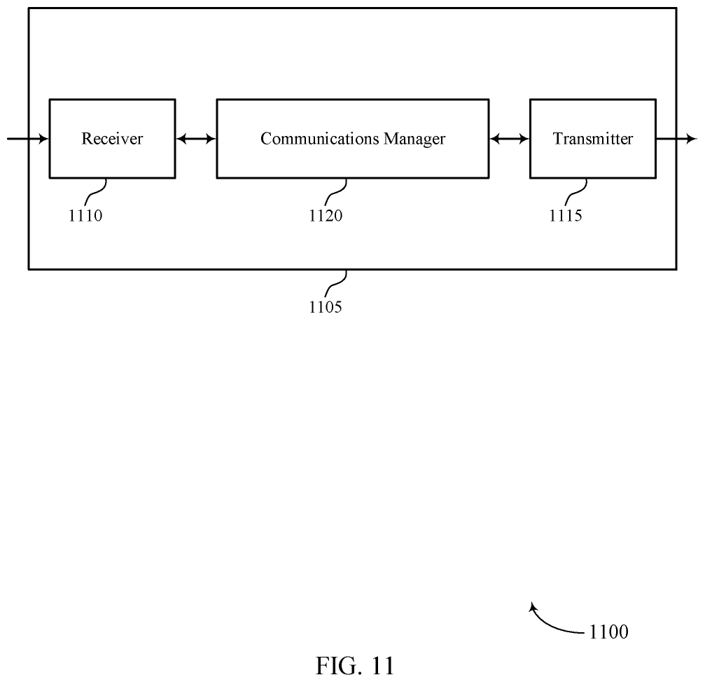

FIG. 11 shows a block diagram 1100 of a device 1105 that supports enhancement for aircraft relaying continuity in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of enhancement for aircraft relaying continuity as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry), in software (e.g., executable by a processor), or any combination thereof. The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software) executed by a processor. If implemented in code executed by a processor, the functions of the communications manager 1120, the receiver 1110, the transmitter 1115, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a relay device of an aircraft in accordance with examples as disclosed herein. For example, the communications manager 1120 may be configured as or otherwise support a means for relaying communications between a UE and a network entity using a first beam associated with the relay device of the aircraft and the UE. The communications manager 1120 may be configured as or otherwise support a means for identifying one or more physical layer parameters associated with a second beam to be used for relaying communications between the UE and the network entity, the second beam associated with the relay device of the aircraft or with a second relay device of a second aircraft. The communications manager 1120 may be configured as or otherwise support a means for transmitting an indication of the one or more physical layer parameters associated with the second beam to the UE.

Additionally, or alternatively, the communications manager 1120 may support wireless communications at a wireless device of an aircraft in accordance with examples as disclosed herein. For example, the communications manager 1120 may be configured as or otherwise support a means for determining that a location of the aircraft is within a first geographic region from a set of geographic regions, each geographic region in the set of geographic regions corresponding to a unique cell identifier used for communications within the geographic region. The communications manager 1120 may be configured as or otherwise support a means for selecting a first cell identifier corresponding to the first geographic region based on the location of the aircraft. The communications manager 1120 may be configured as or otherwise support a means for communicating, while the location of the aircraft is within the first geographic region, with UE located within the first geographic region using the first cell identifier.

Additionally, or alternatively, the communications manager 1120 may support wireless communications at a network entity in accordance with examples as disclosed herein. For example, the communications manager 1120 may be configured as or otherwise support a means for performing relayed communications with a UE via a first relay device of a first aircraft based on a first beam used for relaying communications between the UE and the first relay device. The communications manager 1120 may be configured as or otherwise support a means for identifying one or more physical layer parameters of a second beam to be used for relaying communications between the UE and the network entity, the second beam associated with a second relay device of a second aircraft. The communications manager 1120 may be configured as or otherwise support a means for communicating an indication of the one or more physical layer parameters of the second beam to the UE via the first relay device of the first aircraft.

Additionally, or alternatively, the communications manager 1120 may support wireless communications at a network entity in accordance with examples as disclosed herein. For example, the communications manager 1120 may be configured as or otherwise support a means for identifying a set of geographic regions, each geographic region in the set of geographic regions corresponding to a unique cell identifier used for communications within the geographic region, where the network entity is located within a first geographic region from the set of geographic regions that corresponds to a first cell identifier. The communications manager 1120 may be configured as or otherwise support a means for transmitting an indication of the first cell identifier to an aircraft within the first geographic region, where communications between UE and the aircraft use the first cell identifier.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for signaling physical layer parameters for the next beam to a UE to improve communications between the UE and an aircraft.

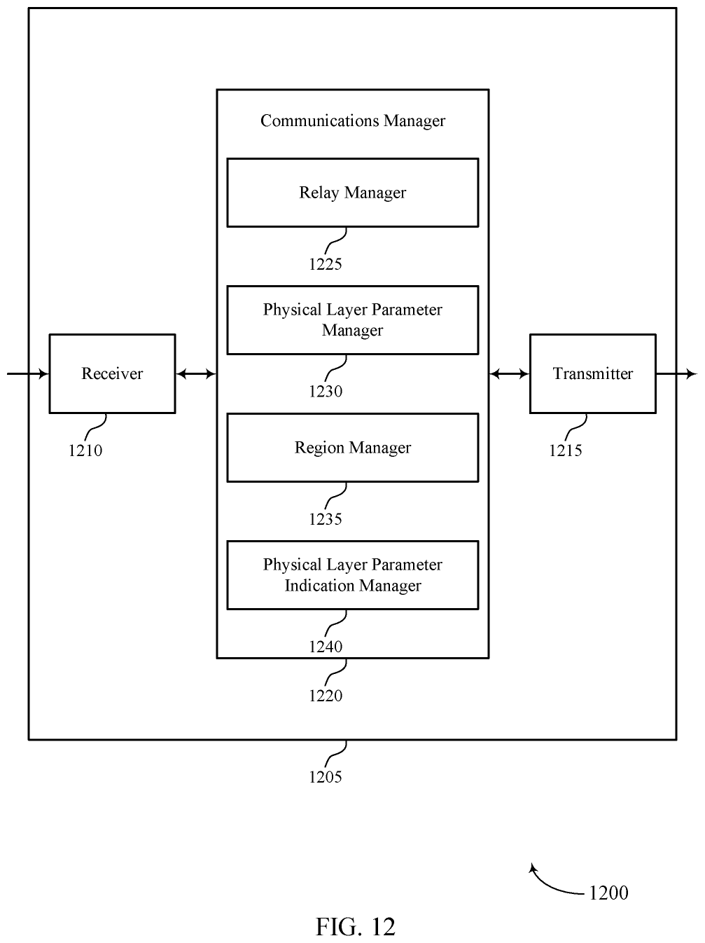

FIG. 12 shows a block diagram 1200 of a device 1205 that supports enhancement for aircraft relaying continuity in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of enhancement for aircraft relaying continuity as described herein. For example, the communications manager 1220 may include a relay manager 1225, a physical layer parameter manager 1230, a region manager 1235, a physical layer parameter indication manager 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a relay device of an aircraft in accordance with examples as disclosed herein. The relay manager 1225 may be configured as or otherwise support a means for relaying communications between a UE and a network entity using a first beam associated with the relay device of the aircraft and the UE. The physical layer parameter manager 1230 may be configured as or otherwise support a means for identifying one or more physical layer parameters associated with a second beam to be used for relaying communications between the UE and the network entity, the second beam associated with the relay device of the aircraft or with a second relay device of a second aircraft. The physical layer parameter manager 1230 may be configured as or otherwise support a means for transmitting an indication of the one or more physical layer parameters associated with the second beam to the UE.

Additionally, or alternatively, the communications manager 1220 may support wireless communications at a wireless device of an aircraft in accordance with examples as disclosed herein. The region manager 1235 may be configured as or otherwise support a means for determining that a location of the aircraft is within a first geographic region from a set of geographic regions, each geographic region in the set of geographic regions corresponding to a unique cell identifier used for communications within the geographic region. The region manager 1235 may be configured as or otherwise support a means for selecting a first cell identifier corresponding to the first geographic region based on the location of the aircraft. The region manager 1235 may be configured as or otherwise support a means for communicating, while the location of the aircraft is within the first geographic region, with UE located within the first geographic region using the first cell identifier.

Additionally, or alternatively, the communications manager 1220 may support wireless communications at a network entity in accordance with examples as disclosed herein. The relay manager 1225 may be configured as or otherwise support a means for performing relayed communications with a UE via a first relay device of a first aircraft based on a first beam used for relaying communications between the UE and the first relay device. The physical layer parameter manager 1230 may be configured as or otherwise support a means for identifying one or more physical layer parameters of a second beam to be used for relaying communications between the UE and the network entity, the second beam associated with a second relay device of a second aircraft. The physical layer parameter indication manager 1240 may be configured as or otherwise support a means for communicating an indication of the one or more physical layer parameters of the second beam to the UE via the first relay device of the first aircraft.

Additionally, or alternatively, the communications manager 1220 may support wireless communications at a network entity in accordance with examples as disclosed herein. The region manager 1235 may be configured as or otherwise support a means for identifying a set of geographic regions, each geographic region in the set of geographic regions corresponding to a unique cell identifier used for communications within the geographic region, where the network entity is located within a first geographic region from the set of geographic regions that corresponds to a first cell identifier. The region manager 1235 may be configured as or otherwise support a means for transmitting an indication of the first cell identifier to an aircraft within the first geographic region, where communications between UE and the aircraft use the first cell identifier.

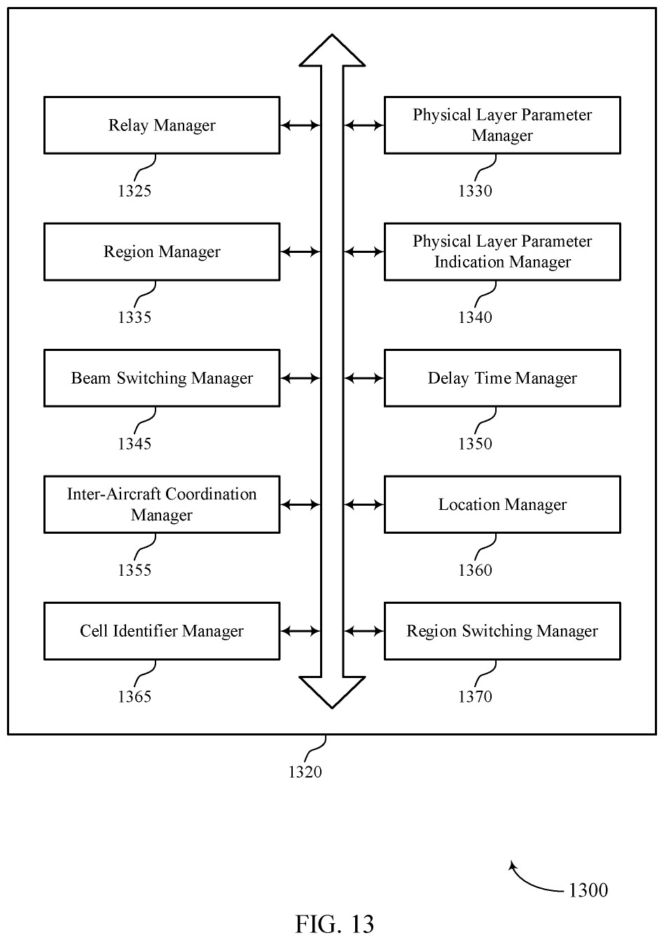

FIG. 13 shows a block diagram 1300 of a communications manager 1320 that supports enhancement for aircraft relaying continuity in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of enhancement for aircraft relaying continuity as described herein. For example, the communications manager 1320 may include a relay manager 1325, a physical layer parameter manager 1330, a region manager 1335, a physical layer parameter indication manager 1340, a beam switching manager 1345, a delay time manager 1350, an inter-aircraft coordination manager 1355, a location manager 1360, a cell identifier manager 1365, a region switching manager 1370, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a relay device of an aircraft in accordance with examples as disclosed herein. The relay manager 1325 may be configured as or otherwise support a means for relaying communications between a UE and a network entity using a first beam associated with the relay device of the aircraft and the UE. The physical layer parameter manager 1330 may be configured as or otherwise support a means for identifying one or more physical layer parameters associated with a second beam to be used for relaying communications between the UE and the network entity, the second beam associated with the relay device of the aircraft or with a second relay device of a second aircraft. In some examples, the physical layer parameter manager 1330 may be configured as or otherwise support a means for transmitting an indication of the one or more physical layer parameters associated with the second beam to the UE.

In some examples, the beam switching manager 1345 may be configured as or otherwise support a means for switching, at the relay device of the aircraft, from the first beam to the second beam in accordance with the one or more physical layer parameters. In some examples, the beam switching manager 1345 may be configured as or otherwise support a means for relaying communications between the UE and the network entity using the second beam associated with the relay device of the aircraft.

In some examples, to support transmitting the indication of the one or more physical layer parameters, the physical layer parameter indication manager 1340 may be configured as or otherwise support a means for identifying a timing advance value, a frequency compensation value, or both, for the second beam based on a delay value, a Doppler shift value, or both, for the second beam. In some examples, to support transmitting the indication of the one or more physical layer parameters, the physical layer parameter indication manager 1340 may be configured as or otherwise support a means for transmitting an indication of the timing advance value, the frequency compensation value, or both, for the second beam, where the UE switching from the first beam to the second beam is based on the timing advance value, the frequency compensation value, or both.

In some examples, to support receiving the indication of the one or more physical layer parameters, the physical layer parameter indication manager 1340 may be configured as or otherwise support a means for identifying a delay value, a Doppler shift value, or both, for the second beam. In some examples, to support receiving the indication of the one or more physical layer parameters, the physical layer parameter indication manager 1340 may be configured as or otherwise support a means for transmitting an indication of the delay value, the Doppler shift value, or both, for the second beam to the UE.

In some examples, the indication of the one or more physical layer parameters is transmitted via an RRC message, a DCI, a medium access control-control element (MAC-CE), a broadcast transmission, a paging message, or any combination thereof.

In some examples, the delay time manager 1350 may be configured as or otherwise support a means for identifying a delay time between the UE receiving the indication and communicating with the network entity using the second beam, where the indication of the one or more physical layer parameters identifies the delay time.

In some examples, the inter-aircraft coordination manager 1355 may be configured as or otherwise support a means for transmitting, to the second relay device of the second aircraft via the network entity or directly via an inter-aircraft link, a location information, a configuration information, a context information, or a combination thereof, for the UE.

In some examples, the location manager 1360 may be configured as or otherwise support a means for receiving an indication of a location information for the UE from the UE. In some examples, the location manager 1360 may be configured as or otherwise support a means for transmitting the location information for the UE to the network entity, where the second beam is based on the location information for the UE.

In some examples, the location manager 1360 may be configured as or otherwise support a means for determining that a location information for the UE is unknown. In some examples, the location manager 1360 may be configured as or otherwise support a means for transmitting an indication of an aircraft location information, a first beam configuration and identifier for the first beam, or both, to the network entity, where the second beam is based on the aircraft location information, the first beam configuration and identifier, or both.

Additionally, or alternatively, the communications manager 1320 may support wireless communications at a wireless device of an aircraft in accordance with examples as disclosed herein. The region manager 1335 may be configured as or otherwise support a means for determining that a location of the aircraft is within a first geographic region from a set of geographic regions, each geographic region in the set of geographic regions corresponding to a unique cell identifier used for communications within the geographic region. In some examples, the region manager 1335 may be configured as or otherwise support a means for selecting a first cell identifier corresponding to the first geographic region based on the location of the aircraft. In some examples, the region manager 1335 may be configured as or otherwise support a means for communicating, while the location of the aircraft is within the first geographic region, with UE located within the first geographic region using the first cell identifier.

In some examples, the cell identifier manager 1365 may be configured as or otherwise support a means for receiving, from a network entity within the first geographic region, an indication of a set of cell identifiers corresponding to the set of geographic regions. In some examples, the cell identifier manager 1365 may be configured as or otherwise support a means for selecting the first cell identifier to be used for the communications with the UE from the set of cell identifiers based on the location of the aircraft.

In some examples, the cell identifier manager 1365 may be configured as or otherwise support a means for receiving an indication of the first cell identifier from a network entity associated with the first geographic region, where the first cell identifier is used for communications with the UE based on the receiving.

In some examples, the region switching manager 1370 may be configured as or otherwise support a means for determining that the aircraft has moved from the first geographic region to a second geographic region from the set of geographic regions. In some examples, the region switching manager 1370 may be configured as or otherwise support a means for selecting a second cell identifier corresponding to the second geographic region to use for communications with UE within the second geographic region based on the aircraft moving to the second geographic region.

Additionally, or alternatively, the communications manager 1320 may support wireless communications at a network entity in accordance with examples as disclosed herein. In some examples, the relay manager 1325 may be configured as or otherwise support a means for performing relayed communications with a UE via a first relay device of a first aircraft based on a first beam used for relaying communications between the UE and the first relay device. In some examples, the physical layer parameter manager 1330 may be configured as or otherwise support a means for identifying one or more physical layer parameters of a second beam to be used for relaying communications between the UE and the network entity, the second beam associated with a second relay device of a second aircraft. The physical layer parameter indication manager 1340 may be configured as or otherwise support a means for communicating an indication of the one or more physical layer parameters of the second beam to the UE via the first relay device of the first aircraft.

In some examples, the delay time manager 1350 may be configured as or otherwise support a means for identifying a delay time between the UE receiving the indication and the UE communicating with the network entity using the second beam, where the indication of the one or more physical layer parameters identifies the delay time.

In some examples, the inter-aircraft coordination manager 1355 may be configured as or otherwise support a means for relaying, from the first aircraft to the second relay device of the second aircraft, a location information, a configuration information, a context information, or a combination thereof, for the UE, where the second beam is based on the location information, the configuration information, the context information, or the combination thereof.

In some examples, the location manager 1360 may be configured as or otherwise support a means for receiving an indication of a location information for the UE. In some examples, the location manager 1360 may be configured as or otherwise support a means for identifying the second beam based on the location information for the UE.

In some examples, the location manager 1360 may be configured as or otherwise support a means for determining that a location information for the UE is unknown. In some examples, the location manager 1360 may be configured as or otherwise support a means for identifying the second beam based on an aircraft location information for the first aircraft, a first beam configuration for the first beam, or both.

Additionally, or alternatively, the communications manager 1320 may support wireless communications at a network entity in accordance with examples as disclosed herein. In some examples, the region manager 1335 may be configured as or otherwise support a means for identifying a set of geographic regions, each geographic region in the set of geographic regions corresponding to a unique cell identifier used for communications within the geographic region, where the network entity is located within a first geographic region from the set of geographic regions that corresponds to a first cell identifier. In some examples, the region manager 1335 may be configured as or otherwise support a means for transmitting an indication of the first cell identifier to an aircraft within the first geographic region, where communications between UE and the aircraft use the first cell identifier.

In some examples, to support transmitting the indication of the first cell identifier, the cell identifier manager 1365 may be configured as or otherwise support a means for transmitting an indication of a set of identifiers corresponding to the set of geographic regions, where the first cell identifier is used for communications between the UE and the aircraft based on a location of the aircraft within the first geographic region.

In some examples, the cell identifier manager 1365 may be configured as or otherwise support a means for determining that the aircraft is within the first geographic region. In some examples, the cell identifier manager 1365 may be configured as or otherwise support a means for transmitting an indication of the first cell identifier to the aircraft based at least part on the aircraft being within the first geographic region.

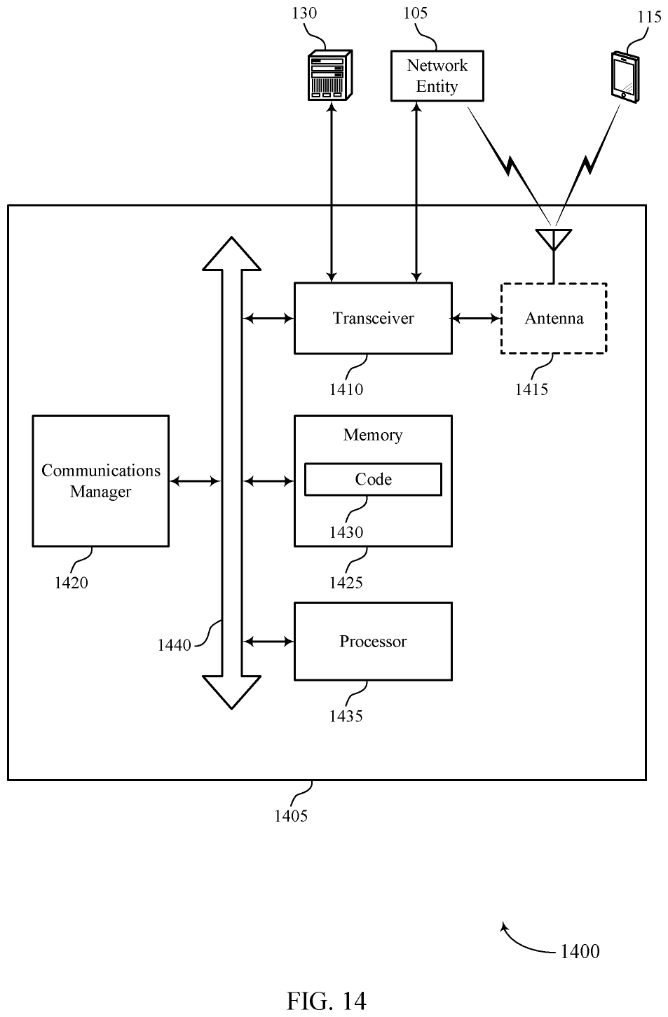

FIG. 14 shows a diagram of a system 1400 including a device 1405 that supports enhancement for aircraft relaying continuity in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting enhancement for aircraft relaying continuity). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a relay device of an aircraft in accordance with examples as disclosed herein. For example, the communications manager 1420 may be configured as or otherwise support a means for relaying communications between a UE and a network entity using a first beam associated with the relay device of the aircraft and the UE. The communications manager 1420 may be configured as or otherwise support a means for identifying one or more physical layer parameters associated with a second beam to be used for relaying communications between the UE and the network entity, the second beam associated with the relay device of the aircraft or with a second relay device of a second aircraft. The communications manager 1420 may be configured as or otherwise support a means for transmitting an indication of the one or more physical layer parameters associated with the second beam to the UE.

Additionally, or alternatively, the communications manager 1420 may support wireless communications at a wireless device of an aircraft in accordance with examples as disclosed herein. For example, the communications manager 1420 may be configured as or otherwise support a means for determining that a location of the aircraft is within a first geographic region from a set of geographic regions, each geographic region in the set of geographic regions corresponding to a unique cell identifier used for communications within the geographic region. The communications manager 1420 may be configured as or otherwise support a means for selecting a first cell identifier corresponding to the first geographic region based on the location of the aircraft. The communications manager 1420 may be configured as or otherwise support a means for communicating, while the location of the aircraft is within the first geographic region, with UE located within the first geographic region using the first cell identifier.

Additionally, or alternatively, the communications manager 1420 may support wireless communications at a network entity in accordance with examples as disclosed herein. For example, the communications manager 1420 may be configured as or otherwise support a means for performing relayed communications with a UE via a first relay device of a first aircraft based on a first beam used for relaying communications between the UE and the first relay device. The communications manager 1420 may be configured as or otherwise support a means for identifying one or more physical layer parameters of a second beam to be used for relaying communications between the UE and the network entity, the second beam associated with a second relay device of a second aircraft. The communications manager 1420 may be configured as or otherwise support a means for communicating an indication of the one or more physical layer parameters of the second beam to the UE via the first relay device of the first aircraft.

Additionally, or alternatively, the communications manager 1420 may support wireless communications at a network entity in accordance with examples as disclosed herein. For example, the communications manager 1420 may be configured as or otherwise support a means for identifying a set of geographic regions, each geographic region in the set of geographic regions corresponding to a unique cell identifier used for communications within the geographic region, where the network entity is located within a first geographic region from the set of geographic regions that corresponds to a first cell identifier. The communications manager 1420 may be configured as or otherwise support a means for transmitting an indication of the first cell identifier to an aircraft within the first geographic region, where communications between UE and the aircraft use the first cell identifier.

By including or configuring the communications manager 1420 in accordance with examples as described herein, the device 1405 may support techniques for signaling physical layer parameters for the next beam to a UE to improve communications between the UE and an aircraft.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of enhancement for aircraft relaying continuity as described herein, or the processor 1435 and the memory 1425 may be otherwise configured to perform or support such operations.

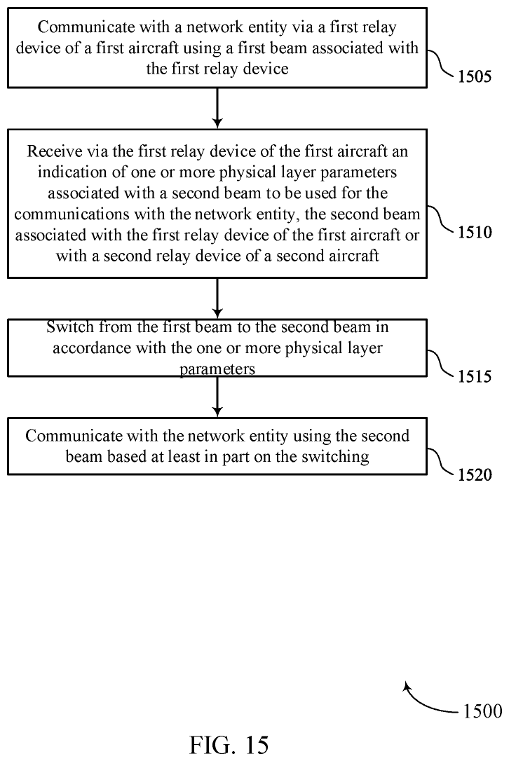

FIG. 15 shows a flowchart illustrating a method 1500 that supports enhancement for aircraft relaying continuity in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include communicating with a network entity via a first relay device of a first aircraft using a first beam associated with the first relay device. The operations of 1505 may be performed in accordance with examples as disclosed herein. In some examples, aspects of the operations of 1505 may be performed by a beam manager 925 as described with reference to FIG. 9.

At 1510, the method may include receiving via the first relay device of the first aircraft an indication of one or more physical layer parameters associated with a second beam to be used for the communications with the network entity, the second beam associated with the first relay device of the first aircraft or with a second relay device of a second aircraft. The operations of 1510 may be performed in accordance with examples as disclosed herein. In some examples, aspects of the operations of 1510 may be performed by a physical layer parameter manager 930 as described with reference to FIG. 9.

At 1515, the method may include switching from the first beam to the second beam in accordance with the one or more physical layer parameters. The operations of 1515 may be performed in accordance with examples as disclosed herein.

In some examples, aspects of the operations of 1515 may be performed by a beam 935 as described with reference to FIG. 9.

At 1520, the method may include communicating with the network entity using the second beam based on the switching. The operations of 1520 may be performed in accordance with examples as disclosed herein. In some examples, aspects of the operations of 1520 may be performed by a beam manager 925 as described with reference to FIG. 9.

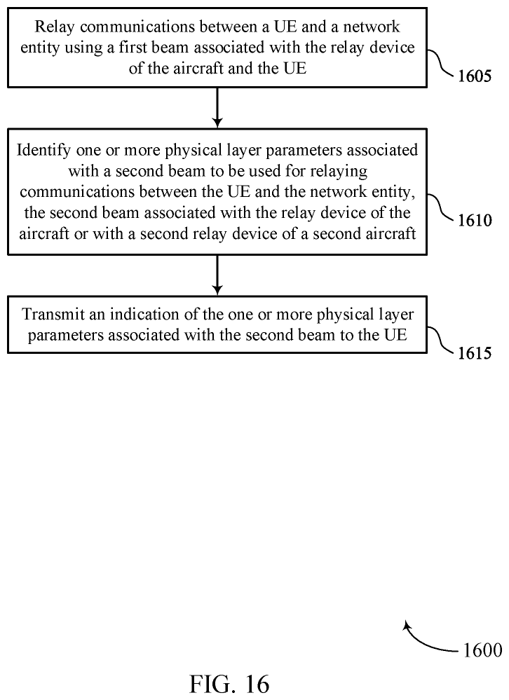

FIG. 16 shows a flowchart illustrating a method 1600 that supports enhancement for aircraft relaying continuity in accordance with one or more aspects of the present disclosure. The operations of the method 1600 may be implemented by a UE or a network entity or its components as described herein. For example, the operations of the method 1600 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include relaying communications between a UE and a network entity using a first beam associated with the relay device of the aircraft and the UE. The operations of 1605 may be performed in accordance with examples as disclosed herein. In some examples, aspects of the operations of 1605 may be performed by a relay manager 940 or a relay manager 1325 as described with reference to FIGS. 9 and 13.

At 1610, the method may include identifying one or more physical layer parameters associated with a second beam to be used for relaying communications between the UE and the network entity, the second beam associated with the relay device of the aircraft or with a second relay device of a second aircraft. The operations of 1610 may be performed in accordance with examples as disclosed herein. In some examples, aspects of the operations of 1610 may be performed by a physical layer parameter manager 930 or a physical layer parameter manager 1330 as described with reference to FIGS. 9 and 13.

At 1615, the method may include transmitting an indication of the one or more physical layer parameters associated with the second beam to the UE. The operations of 1615 may be performed in accordance with examples as disclosed herein. In some examples, aspects of the operations of 1615 may be performed by a physical layer parameter manager 930 or a physical layer parameter manager 1330 as described with reference to FIGS. 9 and 13.

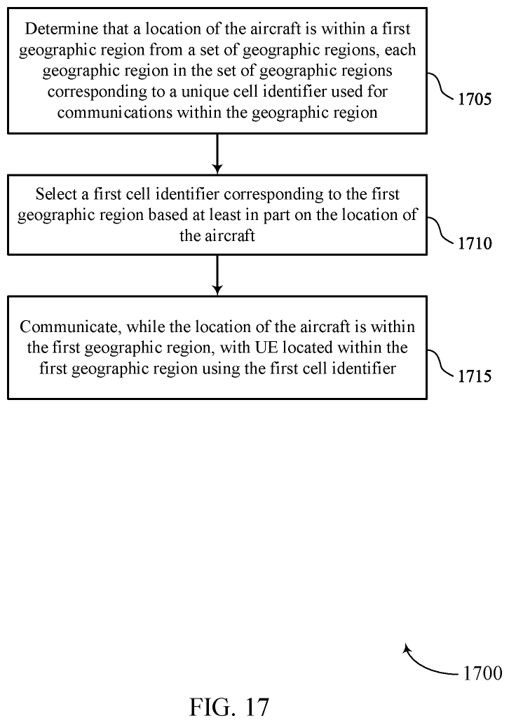

FIG. 17 shows a flowchart illustrating a method 1700 that supports enhancement for aircraft relaying continuity in accordance with one or more aspects of the present disclosure. The operations of the method 1700 may be implemented by a UE or a network entity or its components as described herein. For example, the operations of the method 1700 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include determining that a location of the aircraft is within a first geographic region from a set of geographic regions, each geographic region in the set of geographic regions corresponding to a unique cell identifier used for communications within the geographic region. The operations of 1705 may be performed in accordance with examples as disclosed herein. In some examples, aspects of the operations of 1705 may be performed by a region manager 945 or a region manager 1335 as described with reference to FIGS. 9 and 13.

At 1710, the method may include selecting a first cell identifier corresponding to the first geographic region based on the location of the aircraft. The operations of 1710 may be performed in accordance with examples as disclosed herein. In some examples, aspects of the operations of 1710 may be performed by a region manager 945 or a region manager 1335 as described with reference to FIGS. 9 and 13.

At 1715, the method may include communicating, while the location of the aircraft is within the first geographic region, with UE located within the first geographic region using the first cell identifier. The operations of 1715 may be performed in accordance with examples as disclosed herein. In some examples, aspects of the operations of 1715 may be performed by a region manager 945 or a region manager 1335 as described with reference to FIGS. 9 and 13.

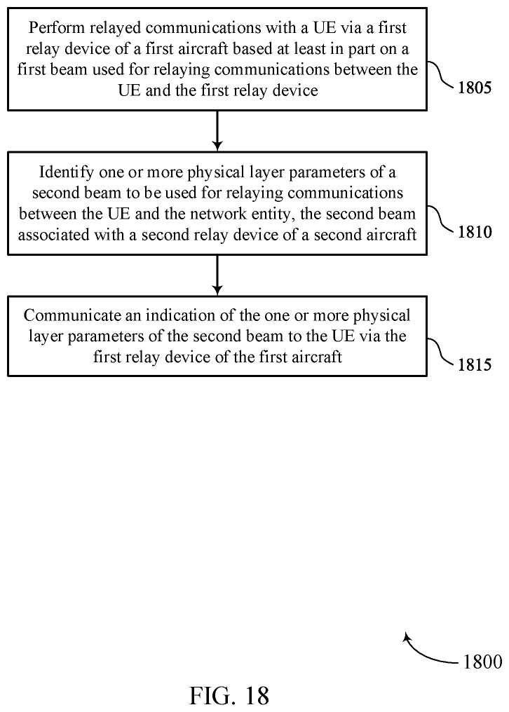

FIG. 18 shows a flowchart illustrating a method 1800 that supports enhancement for aircraft relaying continuity in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include performing relayed communications with a UE via a first relay device of a first aircraft based on a first beam used for relaying communications between the UE and the first relay device. The operations of 1805 may be performed in accordance with examples as disclosed herein. In some examples, aspects of the operations of 1805 may be performed by a relay manager 1325 as described with reference to FIG. 13.

At 1810, the method may include identifying one or more physical layer parameters of a second beam to be used for relaying communications between the UE and the network entity, the second beam associated with a second relay device of a second aircraft. The operations of 1810 may be performed in accordance with examples as disclosed herein. In some examples, aspects of the operations of 1810 may be performed by a physical layer parameter manager 1330 as described with reference to FIG. 13.

At 1815, the method may include communicating an indication of the one or more physical layer parameters of the second beam to the UE via the first relay device of the first aircraft. The operations of 1815 may be performed in accordance with examples as disclosed herein. In some examples, aspects of the operations of 1815 may be performed by a physical layer parameter indication manager 1340 as described with reference to FIG. 13.

The following provides an overview of aspects of the present disclosure:
Aspect 1: A method for wireless communication at a UE, comprising: communicating with a network entity via a first relay device of a first aircraft using a first beam associated with the first relay device; receiving via the first relay device of the first aircraft an indication of one or more physical layer parameters associated with a second beam to be used for the communications with the network entity, the second beam associated with the first relay device of the first aircraft or with a second relay device of a second aircraft; switching from the first beam to the second beam in accordance with the one or more physical layer parameters; and communicating with the network entity using the second beam based at least in part on the switching.
Aspect 2: The method of aspect 1, wherein receiving the indication of the one or more physical layer parameters comprises: receiving an indication of a timing advance value, a frequency compensation value, or both, for the second beam; and switching to the second beam based at least in part on the timing advance value, the frequency compensation value, or both.
Aspect 3: The method of any of aspects 1 through 2, wherein receiving the indication of the one or more physical layer parameters comprises: receiving an indication of a delay value, a Doppler shift value, or both, for the second beam; identifying a timing advance value, a frequency compensation value, or both, for the second beam based at least in part on the delay value, the Doppler shift value, or both; and switching to the second beam based at least in part on the timing advance value, the frequency compensation value, or both.
Aspect 4: The method of any of aspects 1 through 3, wherein the indication of the one or more physical layer parameters is received via an RRC message, a DCI, a MAC-CE, a broadcast transmission, a paging message, or any combination thereof.
Aspect 5: The method of any of aspects 1 through 4, further comprising: identifying, based at least in part on the indication of one or more physical layer parameters, a delay time between receiving the indication and communicating with the network entity using the second beam, wherein the switching is based at least in part on the delay time.
Aspect 6: The method of any of aspects 1 through 5, wherein communicating with the network entity via the first relay device of the first aircraft comprises: transmitting an indication of a location information for the UE to the network entity via the first relay device of the first aircraft, wherein the second beam is based at least in part on the location information for the UE relative to the first aircraft or to the second aircraft.
Aspect 7: The method of any of aspects 1 through 6, further comprising: determining an identifier associated with the communications between the UE and the network entity via the first relay device of the first aircraft; and maintaining the identifier when communicating with the network entity using the second beam via the second relay device of the second aircraft.
Aspect 8: A method for wireless communication at a relay device of an aircraft, comprising: relaying communications between a UE and a network entity using a first beam associated with the relay device of the aircraft and the UE; identifying one or more physical layer parameters associated with a second beam to be used for relaying communications between the UE and the network entity, the second beam associated with the relay device of the aircraft or with a second relay device of a second aircraft; and transmitting an indication of the one or more physical layer parameters associated with the second beam to the UE.
Aspect 9: The method of aspect 8, further comprising: switching, at the relay device of the aircraft, from the first beam to the second beam in accordance with the one or more physical layer parameters; and relaying communications between the UE and the network entity using the second beam associated with the relay device of the aircraft.
Aspect 10: The method of any of aspects 8 through 9, wherein transmitting the indication of the one or more physical layer parameters comprises: identifying a timing advance value, a frequency compensation value, or both, for the second beam based at least in part on a delay value, a Doppler shift value, or both, for the second beam; and transmitting an indication of the timing advance value, the frequency compensation value, or both, for the second beam, wherein the UE switching from the first beam to the second beam is based at least in part on the timing advance value, the frequency compensation value, or both.
Aspect 11: The method of any of aspects 8 through 10, wherein receiving the indication of the one or more physical layer parameters comprises: identifying a delay value, a Doppler shift value, or both, for the second beam; and transmitting an indication of the delay value, the Doppler shift value, or both, for the second beam to the UE.
Aspect 12: The method of any of aspects 8 through 11, wherein the indication of the one or more physical layer parameters is transmitted via an RRC message, a DCI, a MAC-CE, a broadcast transmission, a paging message, or any combination thereof.
Aspect 13: The method of any of aspects 8 through 12, further comprising: identifying a delay time between the UE receiving the indication and communicating with the network entity using the second beam, wherein the indication of the one or more physical layer parameters identifies the delay time.
Aspect 14: The method of any of aspects 8 through 13, further comprising: transmitting, to the second relay device of the second aircraft via the network entity or directly via an inter-aircraft link, a location information, a configuration information, a context information, or a combination thereof, for the UE.
Aspect 15: The method of any of aspects 8 through 14, further comprising: receiving an indication of a location information for the UE from the UE; and transmitting the location information for the UE to the network entity, wherein the second beam is based at least in part on the location information for the UE.
Aspect 16: The method of any of aspects 8 through 15, further comprising: determining that a location information for the UE is unknown; and transmitting an indication of an aircraft location information, a first beam configuration and identifier for the first beam, or both, to the network entity, wherein the second beam is based at least in part on the aircraft location information, the first beam configuration and identifier, or both.
Aspect 17: A method for wireless communications at a wireless device of an aircraft, comprising: determining that a location of the aircraft is within a first geographic region from a set of geographic regions, each geographic region in the set of geographic regions corresponding to a unique cell identifier used for communications within the geographic region; selecting a first cell identifier corresponding to the first geographic region based at least in part on the location of the aircraft; and communicating, while the location of the aircraft is within the first geographic region, with UE located within the first geographic region using the first cell identifier.
Aspect 18: The method of aspect 17, further comprising: receiving, from a network entity within the first geographic region, an indication of a set of cell identifiers corresponding to the set of geographic regions; and selecting the first cell identifier to be used for the communications with the UE from the set of cell identifiers based at least in part on the location of the aircraft.
Aspect 19: The method of any of aspects 17 through 18, further comprising: receiving an indication of the first cell identifier from a network entity associated with the first geographic region, wherein the first cell identifier is used for communications with the UE based at least in part on the receiving.
Aspect 20: The method of any of aspects 17 through 19, further comprising: determining that the aircraft has moved from the first geographic region to a second geographic region from the set of geographic regions; and selecting a second cell identifier corresponding to the second geographic region to use for communications with UE within the second geographic region based at least in part on the aircraft moving to the second geographic region.
Aspect 21: A method for wireless communications at a network entity, comprising: performing relayed communications with a UE via a first relay device of a first aircraft based at least in part on a first beam used for relaying communications between the UE and the first relay device; identifying one or more physical layer parameters of a second beam to be used for relaying communications between the UE and the network entity, the second beam associated with a second relay device of a second aircraft; and communicating an indication of the one or more physical layer parameters of the second beam to the UE via the first relay device of the first aircraft.
Aspect 22: The method of aspect 21, further comprising: identifying a delay time between the UE receiving the indication and the UE communicating with the network entity using the second beam, wherein the indication of the one or more physical layer parameters identifies the delay time.
Aspect 23: The method of any of aspects 21 through 22, further comprising: relaying, from the first aircraft to the second relay device of the second aircraft, a location information, a configuration information, a context information, or a combination thereof, for the UE, wherein the second beam is based at least in part on the location information, the configuration information, the context information, or the combination thereof.
Aspect 24: The method of any of aspects 21 through 23, further comprising: receiving an indication of a location information for the UE; and identifying the second beam based at least in part on the location information for the UE.
Aspect 25: The method of any of aspects 21 through 24, further comprising: determining that a location information for the UE is unknown; and identifying the second beam based at least in part on an aircraft location information for the first aircraft, a first beam configuration for the first beam, or both.
Aspect 26: a method for wireless communications at a network entity, comprising: identifying a set of geographic regions, each geographic region in the set of geographic regions corresponding to a unique cell identifier used for communications within the geographic region, wherein the network entity is located within a first geographic region from the set of geographic regions that corresponds to a first cell identifier; and transmitting an indication of the first cell identifier to an aircraft within the first geographic region, wherein communications between UE and the aircraft use the first cell identifier.
Aspect 27: The method of aspect 26, wherein transmitting the indication of the first cell identifier comprises: transmitting an indication of a set of identifiers corresponding to the set of geographic regions, wherein the first cell identifier is used for communications between the UE and the aircraft based at least in part on a location of the aircraft within the first geographic region.
Aspect 28: The method of any of aspects 26 through 27, further comprising: determining that the aircraft is within the first geographic region; and transmitting an indication of the first cell identifier to the aircraft based at least part on the aircraft being within the first geographic region.
Aspect 29: An apparatus for wireless communication at a UE, comprising a processor; memory coupled with the processor; and instructions stored in the memory and executable by the processor to cause the apparatus to perform a method of any of aspects 1 through 7.
Aspect 30: An apparatus for wireless communication at a UE, comprising at least one means for performing a method of any of aspects 1 through 7.
Aspect 31: A non-transitory computer-readable medium storing code for wireless communication at a UE, the code comprising instructions executable by a processor to perform a method of any of aspects 1 through 7.
Aspect 32: An apparatus for wireless communication at a relay device of an aircraft, comprising a processor; memory coupled with the processor; and instructions stored in the memory and executable by the processor to cause the apparatus to perform a method of any of aspects 8 through 16.
Aspect 33: An apparatus for wireless communication at a relay device of an aircraft, comprising at least one means for performing a method of any of aspects 8 through 16.
Aspect 34: A non-transitory computer-readable medium storing code for wireless communication at a relay device of an aircraft, the code comprising instructions executable by a processor to perform a method of any of aspects 8 through 16.
Aspect 35: An apparatus for wireless communications at a wireless device of an aircraft, comprising a processor; memory coupled with the processor; and instructions stored in the memory and executable by the processor to cause the apparatus to perform a method of any of aspects 17 through 20.
Aspect 36: An apparatus for wireless communications at a wireless device of an aircraft, comprising at least one means for performing a method of any of aspects 17 through 20.
Aspect 37: A non-transitory computer-readable medium storing code for wireless communications at a wireless device of an aircraft, the code comprising instructions executable by a processor to perform a method of any of aspects 17 through 20.
Aspect 38: An apparatus for wireless communications at a network entity, comprising a processor; memory coupled with the processor; and instructions stored in the memory and executable by the processor to cause the apparatus to perform a method of any of aspects 21 through 25.
Aspect 39: An apparatus for wireless communications at a network entity, comprising at least one means for performing a method of any of aspects 21 through 25.
Aspect 40: A non-transitory computer-readable medium storing code for wireless communications at a network entity, the code comprising instructions executable by a processor to perform a method of any of aspects 21 through 25.
Aspect 41: An apparatus for wireless communications at a network entity, comprising a processor; memory coupled with the processor; and instructions stored in the memory and executable by the processor to cause the apparatus to perform a method of any of aspects 26 through 28.
Aspect 42: An apparatus for wireless communications at a network entity, comprising at least one means for performing a method of any of aspects 26 through 28.
Aspect 43: A non-transitory computer-readable medium storing code for wireless communications at a network entity, the code comprising instructions executable by a processor to perform a method of any of aspects 26 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Components within a wireless communications system may be coupled (for example, operatively, communicatively, functionally, electronically, and/or electrically) to each other.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Software shall be construed broadly to mean instructions, instruction sets, code, code segments, program code, programs, subprograms, software modules, applications, software applications, software packages, routines, subroutines, objects, executables, threads of execution, procedures, or functions, etc., whether referred to as software, firmware, middleware, microcode, hardware description language, or otherwise.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), or ascertaining. Also, “determining” can include receiving (e.g., receiving information) or accessing (e.g., accessing data stored in memory). Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled with the at least one processor, the memory storing instructions executable by the at least one processor to cause the UE to:
communicate with a network entity via a first relay device of a first aircraft using a first beam associated with the first relay device;
receive via the first relay device of the first aircraft an indication of one or more physical layer parameters associated with a second beam to be used for the communications with the network entity, the second beam associated with the first relay device of the first aircraft or with a second relay device of a second aircraft;
switch from the first beam to the second beam in accordance with the one or more physical layer parameters; and
communicate with the network entity using the second beam based at least in part on the switching.

2. The apparatus of claim 1, wherein the instructions to receive the indication of the one or more physical layer parameters are executable by the at least one processor to cause the UE to:
receive an indication of a timing advance value, a frequency compensation value, or both, for the second beam; and
switch to the second beam based at least in part on the timing advance value, the frequency compensation value, or both.

3. The apparatus of claim 1, wherein the instructions to receive the indication of the one or more physical layer parameters are executable by the at least one processor to cause the UE to:
receive an indication of a delay value, a Doppler shift value, or both, for the second beam;
identify a timing advance value, a frequency compensation value, or both, for the second beam based at least in part on the delay value, the Doppler shift value, or both; and
switch to the second beam based at least in part on the timing advance value, the frequency compensation value, or both.

4. The apparatus of claim 1, wherein the indication of the one or more physical layer parameters is received via a radio resource control (RRC) message, a downlink control information (DCI), a medium access control-control element (MAC-CE), a broadcast transmission, a paging message, or any combination thereof.

5. The apparatus of claim 1, wherein the instructions are further executable by the at least one processor to cause the UE to:
identify, based at least in part on the indication of one or more physical layer parameters, a delay time between receiving the indication and communicating with the network entity using the second beam, wherein the switching is based at least in part on the delay time.

6. The apparatus of claim 1, wherein the instructions to communicate with the network entity via the first relay device of the first aircraft are executable by the at least one processor to cause the UE to:
transmit an indication of a location information for the UE to the network entity via the first relay device of the first aircraft, wherein the second beam is based at least in part on the location information for the UE relative to the first aircraft or to the second aircraft.

7. The apparatus of claim 1, wherein the instructions are further executable by the at least one processor to cause the UE to:
determine an identifier associated with the communications between the UE and the network entity via the first relay device of the first aircraft; and
maintain the identifier when communicating with the network entity using the second beam via the second relay device of the second aircraft.

8. An apparatus for wireless communication at a relay device of an aircraft, comprising:
at least one processor; and
memory coupled with the processor, the memory storing instructions executable by the at least one processor to cause the relay device to:
relay communications between a user equipment (UE) and a network entity using a first beam associated with the relay device of the aircraft and the UE;
identify one or more physical layer parameters associated with a second beam to be used for relaying communications between the UE and the network entity, the second beam associated with the relay device of the aircraft or with a second relay device of a second aircraft; and
transmit an indication of the one or more physical layer parameters associated with the second beam to the UE.

9. The apparatus of claim 8, wherein the instructions are further executable by the at least one processor to cause the relay device to:
switching, at the relay device of the aircraft, from the first beam to the second beam in accordance with the one or more physical layer parameters; and
relay communications between the UE and the network entity using the second beam associated with the relay device of the aircraft.

10. The apparatus of claim 8, wherein the instructions to transmit the indication of the one or more physical layer parameters are executable by the at least one processor to cause the relay device to:
identify a timing advance value, a frequency compensation value, or both, for the second beam based at least in part on a delay value, a Doppler shift value, or both, for the second beam; and
transmit an indication of the timing advance value, the frequency compensation value, or both, for the second beam, wherein the UE switching from the first beam to the second beam is based at least in part on the timing advance value, the frequency compensation value, or both.

11. The apparatus of claim 8, wherein the instructions to receive the indication of the one or more physical layer parameters are executable by the at least one processor to cause the relay device to:
identify a delay value, a Doppler shift value, or both, for the second beam; and
transmit an indication of the delay value, the Doppler shift value, or both, for the second beam to the UE.

12. The apparatus of claim 8, wherein the indication of the one or more physical layer parameters is transmitted via a radio resource control (RRC) message, a downlink control information (DCI), a medium access control-control element (MAC-CE), a broadcast transmission, a paging message, or any combination thereof.

13. The apparatus of claim 8, wherein the instructions are further executable by the at least one processor to cause the relay device to:
identify a delay time between the UE receiving the indication and communicating with the network entity using the second beam, wherein the indication of the one or more physical layer parameters identifies the delay time.

14. The apparatus of claim 8, wherein the instructions are further executable by the at least one processor to cause the relay device to:
transmit, to the second relay device of the second aircraft via the network entity or directly via an inter-aircraft link, a location information, a configuration information, a context information, or a combination thereof, for the UE.

15. The apparatus of claim 8, wherein the instructions are further executable by the at least one processor to cause the relay device to:
receive an indication of a location information for the UE from the UE; and
transmit the location information for the UE to the network entity, wherein the second beam is based at least in part on the location information for the UE.

16. The apparatus of claim 8, wherein the instructions are further executable by the at least one processor to cause the relay device to:
determine that a location information for the UE is unknown; and
transmit an indication of an aircraft location information, a first beam configuration and identifier for the first beam, or both, to the network entity, wherein the second beam is based at least in part on the aircraft location information, the first beam configuration and identifier, or both.

17. An apparatus for wireless communications at a network entity, comprising:
at least one processor; and
memory coupled with the at least one processor, the memory storing instructions executable by the at least one processor to cause the network entity to:
perform relayed communications with a user equipment (UE) via a first relay device of a first aircraft based at least in part on a first beam used for relaying communications between the UE and the first relay device;
identify one or more physical layer parameters of a second beam to be used for relaying communications between the UE and the network entity, the second beam associated with a second relay device of a second aircraft; and
communicate an indication of the one or more physical layer parameters of the second beam to the UE via the first relay device of the first aircraft.

18. The apparatus of claim 17, wherein the instructions are further executable by the at least one processor to cause the network entity to:
identify a delay time between the UE receiving the indication and the UE communicating with the network entity using the second beam, wherein the indication of the one or more physical layer parameters identifies the delay time.

19. The apparatus of claim 17, wherein the instructions are further executable by the at least one processor to cause the network entity to:
relay, from the first aircraft to the second relay device of the second aircraft, a location information, a configuration information, a context information, or a combination thereof, for the UE, wherein the second beam is based at least in part on the location information, the configuration information, the context information, or the combination thereof.

20. The apparatus of claim 17, wherein the instructions are further executable by the at least one processor to cause the network entity to:
receive an indication of a location information for the UE; and
identify the second beam based at least in part on the location information for the UE.

21. The apparatus of claim 17, wherein the instructions are further executable by the at least one processor to cause the network entity to:
determine that a location information for the UE is unknown; and
identify the second beam based at least in part on an aircraft location information for the first aircraft, a first beam configuration for the first beam, or both.

22. A method for wireless communication at a user equipment (UE), comprising:
communicating with a network entity via a first relay device of a first aircraft using a first beam associated with the first relay device;
receiving via the first relay device of the first aircraft an indication of one or more physical layer parameters associated with a second beam to be used for the communications with the network entity, the second beam associated with the first relay device of the first aircraft or with a second relay device of a second aircraft;
switching from the first beam to the second beam in accordance with the one or more physical layer parameters; and
communicating with the network entity using the second beam based at least in part on the switching.

23. The method of claim 22, wherein receiving the indication of the one or more physical layer parameters comprises:
receiving an indication of a timing advance value, a frequency compensation value, or both, for the second beam; and
switching to the second beam based at least in part on the timing advance value, the frequency compensation value, or both.

24. The method of claim 22, wherein receiving the indication of the one or more physical layer parameters comprises:
receiving an indication of a delay value, a Doppler shift value, or both, for the second beam;
identifying a timing advance value, a frequency compensation value, or both, for the second beam based at least in part on the delay value, the Doppler shift value, or both; and
switching to the second beam based at least in part on the timing advance value, the frequency compensation value, or both.

25. The method of claim 22, wherein the indication of the one or more physical layer parameters is received via a radio resource control (RRC) message, a downlink control information (DCI), a medium access control-control element (MAC-CE), a broadcast transmission, a paging message, or any combination thereof.

26. The method of claim 22, further comprising:
identifying, based at least in part on the indication of one or more physical layer parameters, a delay time between receiving the indication and communicating with the network entity using the second beam, wherein the switching is based at least in part on the delay time.

27. The method of claim 22, wherein communicating with the network entity via the first relay device of the first aircraft comprises:
transmitting an indication of a location information for the UE to the network entity via the first relay device of the first aircraft, wherein the second beam is based at least in part on the location information for the UE relative to the first aircraft or to the second aircraft.

28. The method of claim 22, further comprising:
determining an identifier associated with the communications between the UE and the network entity via the first relay device of the first aircraft; and
maintaining the identifier when communicating with the network entity using the second beam via the second relay device of the second aircraft.
